(19) United States
(12) Patent Application Publication
(10) Pub. No.: US 2026/0272766 A1
(43) Pub. Date: Sep. 17, 2026

(54) METHODS AND SYSTEMS FOR PROVIDING AN INTERACTIVE PLATFORM TO GENERATE AT LEAST ONE CONTROL PATTERN TO CONTROL ADULT TOYS

(71) Applicant: HYTTO PTE. LTD, Singapore (SG)

(72) Inventors: Jilin QIU, Singapore (SG); Jiajun LUO, Guangzhou (CN); Hequan CEN, Guangzhou (CN)

(73) Assignee: HYTTO PTE. LTD, Singapore (SG)

(21) Appl. No.: 19/682,515

(22) Filed: May 20, 2026

Related U.S. Application Data
(63) Continuation-in-part of application No. 19/300,340, filed on Aug. 14, 2025.
Application No. 19/300,340 is a continuation of application No. 18/646,182, filed on Apr. 25, 2024, now Pat. No. 12,396,917.
Application No. 18/646,182 is a continuation-in-part of application No. 18/928,125, filed on Oct. 27, 2024, now Pat. No. 12,433,816.
Application No. 19/300,340 is a continuation-in-part of application No. 17/221,823, filed on Apr. 4, 2021, now Pat. No. 12,433,820.
Application No. 17/221,823 is a continuation-in-part of application No. 16/369,143, filed on Mar. 29, 2019, now Pat. No. 10,999,608.
(63) Continuation-in-part of application No. 19/350,878, filed on Oct. 6, 2025.
Application No. 19/350,878 is a continuation-in-part of application No. 18/928,125, filed on Oct. 27, 2024, now Pat. No. 12,433,816.
Application No. 19/350,878 is a continuation-in-part of application No. 18/825,346, filed on Sep. 5, 2024, now Pat. No. 12,667,513.
(60) Provisional application No. 63/594,930, filed on Oct. 31, 2023.
(60) Provisional application No. 63/594,930, filed on Oct. 31, 2023.
(60) Provisional application No. 63/594,930, filed on Oct. 31, 2023.

(51) Int. Cl. A61H 19/00

(52) U.S. Cl. CPC A61H 19/32; A61H 19/34; A61H 19/44; A61H 2201/1207; A61H 2201/5015; A61H 2201/503; A61H 2201/5092; A61H 2201/5097

(57) ABSTRACT

Embodiments of the present disclosure relate to methods and systems for providing an interactive platform for adult entertainment. A system maintains a set of interactive contents associated with at least one control pattern for at least one sexual stimulation device. Each interactive content includes social feature information generated based on interaction inputs of at least one creator of the interactive platform, and the social feature information characterizes control features of the control pattern. The system receives a request from a user to access the interactive contents associated with the control pattern, renders the interactive contents to enable a preview of at least a portion of the control features, and transmits the rendered interactive contents to the user's device for display.

### CROSS REFERENCE TO RELATED APPLICATIONS

This application is a Continuation-in-Part Application of U.S. application Ser. No. 19/300,340, filed Aug. 14, 2025, which is a Continuation of U.S. application Ser. No. 18/646,182, filed Apr. 25, 2024, now U.S. Pat. No. 12,396,917, issued Aug. 26, 2025. U.S. application Ser. No. 19/300,340 is also a Continuation-in-Part of U.S. application Ser. No. 18/928,125, filed Oct. 27, 2024, now U.S. Pat. No. 12,433,816, issued Oct. 7, 2025, which claims the benefit of Provisional Application No. 63/594,930, filed Oct. 31, 2023. U.S. application Ser. No. 19/300,340 is also in Continuation-in-Part of U.S. application Ser. No. 17/221,823, filed Apr. 4, 2021, now U.S. Pat. No. 12,433,820, issued Oct. 7, 2025, which is a Continuation-in-Part Application of U.S. application Ser. No. 16/369,143, filed Mar. 29, 2019, and issued as U.S. Pat. No. 10,999,608 on May 4, 2021. This application is also a Continuation-in-Part Application of U.S. application Ser. No. 19/350,878, filed Oct. 6, 2025, which is a Continuation-in-Part of U.S. application Ser. No. 18/928,125, filed Oct. 27, 2024, now U.S. Pat. No. 12,433,816, issued Oct. 7, 2025, which claims the benefit of Provisional Application No. 63/594,930, filed Oct. 31, 2023. U.S. application Ser. No. 19/350,878 is also a Continuation-in-Part of U.S. application Ser. No. 18/825,346, filed Sep. 5, 2024, which claims the benefit of Provisional Application No. 63/594,930, filed Oct. 31, 2023. Each of the above applications is hereby incorporated by reference in its entirety.

### TECHNICAL FIELD

The present disclosure relates to adult entertainment control systems, and more particularly to systems and methods for generating, analyzing, and executing at least one control pattern for controlling adult toys.

### BACKGROUND

Remotely controllable sex toys, are increasingly operated using control parameter sets transmitted from user terminals such as smartphones or tablets. These control parameter sets typically define operational characteristics of the sex toy over time, such as intensity, frequency, or mode transitions. Existing systems commonly allow users to create, store, and share such control patterns through mobile applications or online repositories.

Further, conventional pattern-sharing platforms primarily function as static libraries that enable users to upload and download predefined control patterns of the sex toys, which may not effectively convey dynamic characteristics of the control pattern of the sex toy.

### SUMMARY

Various embodiments of the present disclosure disclose methods and systems for providing an interactive platform for adult entertainment.

In an embodiment, a computer-implemented method is disclosed. The computer-implemented method performed by a system includes maintaining a set of interactive contents associated with at least one control pattern for at least one sexual stimulation device, wherein each of the set of interactive contents comprises a set of social feature information generated based on interaction inputs of at least one creator of the interactive platform, and the set of social feature information characterizes control features of the at least one control pattern. Further, the method includes receiving a request from a user of a plurality of users of the interactive platform to access the set of interactive contents associated with the at least one control pattern. The method further includes rendering the set of interactive contents associated with the at least one control pattern in response to the request, wherein the rendered set of interactive contents enable a preview of at least a portion of the control features of the at least one control pattern. Further, the method includes transmitting the rendered set of interactive contents to a user device of the user for display.

In another embodiment, a system is disclosed. The system includes a memory configured to store instructions, and a processor communicably coupled to the memory. The processor is configured to execute the instructions stored in the memory and thereby cause the system to maintain a set of interactive contents associated with at least one control pattern for at least one sexual stimulation device, wherein each of the set of interactive contents comprises a set of social feature information generated based on interaction inputs of at least one creator of the interactive platform, and the set of social feature information characterizes control features of the at least one control pattern. Further, the system is configured to receive a request from a user of a plurality of users of the interactive platform to access the set of interactive contents associated with the at least one control pattern and render the set of interactive contents in response to the request, wherein the rendered set of interactive contents enable a preview of at least a portion of the control features of the at least one control pattern. The system is further configured to transmit the rendered set of interactive contents to a user device of the user for display.

In another embodiment, a computer-implemented method is disclosed. The computer-implemented method performed by a system includes receiving a plurality of timestamped feedback data regarding at least one control pattern from a creator of an interactive platform via a first device during a period in which the creator applies the at least one control pattern to control at least one sexual stimulation device or creates the at least one control pattern, and associating each of the plurality of feedback data with a corresponding timestamp on a timeline of the at least one control pattern to generate an interactive record corresponding to the at least one control pattern. Further, the method includes saving the interactive record, and replaying the interactive record synchronously with the timeline of the at least one control pattern via a second device in response to a browse request for the interactive record from a user of the interactive platform, such that the plurality of feedback data are presented sequentially based on a chronological order of the timestamps during replay.

### BRIEF DESCRIPTION OF THE FIGURES

The following detailed description of illustrative embodiments is better understood when read in conjunction with the appended drawings. For the purposes of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers:

FIG. 1 illustrates an example representation of an environment related to at least some example embodiments of the present disclosure;

FIG. 2 illustrates a simplified block diagram of a system for providing adult entertainment, in accordance with an embodiment of the present disclosure;

FIGS. 3A-3D illustrate exemplary user interfaces for browsing and accessing virtual rooms, previewing control patterns, enabling synchronous device control, and facilitating connectivity and interaction between users within the interactive platform, in accordance with an embodiment of the present disclosure;

FIG. 3E illustrates an example user interface (UI) for avatar customization, in accordance with an embodiment of the present disclosure;

FIGS. 3F and 3G illustrate exemplary user interfaces for segment-based preview of a control pattern, and heatmap-based visualization of timestamped feedback associated with the control pattern, in accordance with an embodiment of the present disclosure;

FIG. 4 illustrates a flow diagram of a computer-implemented method for providing adult entertainment, in accordance with an embodiment of the present disclosure;

FIG. 5 is a simplified block diagram of an electronic device capable of implementing various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features.

### Overview

The present disclosure provides computer-implemented methods and systems for generating, managing, sharing, and executing control patterns for at least one sexual stimulation device through an interactive platform. A system maintains a set of interactive contents associated with at least one control pattern for the sexual stimulation device (i.e., sex toy), wherein each interactive content comprises a set of social feature information generated based on interaction inputs of at least a creator, and the social feature information characterizes control features of the control pattern. Upon receiving a request from a user, the system renders the set of interactive contents associated with the control pattern to enable a preview of at least a portion of the control features, and transmits the rendered interactive contents to a user device of the user for display. In response to an interaction instruction, the system transmits the control pattern to a user device to operate a sexual stimulation device communicably coupled to the user device. In some embodiments, the set of control parameters corresponds to a temporal discrete command sequence arranged sequentially according to timestamps. The system may receive feedback data based on operation of the sexual stimulation device and generate updated interactive contents, selectively augmenting the original interactive contents based on predefined rules and corresponding timestamps. In another embodiment, the system receives a plurality of timestamped feedback data from a creator during control pattern creation or operation, associates each feedback data with a corresponding timeline timestamp to generate an interactive record, and replays the interactive record synchronously with the control pattern timeline for a browsing user.

Further, the system may create virtual rooms associated with control patterns and generate virtual room elements, including background patterns, animations, and audio data, based on analysis of the control parameters. The system enables synchronous control of sexual stimulation devices of multiple users within a virtual room and may dynamically generate modified control parameters based on monitored room conditions, including feedback data, number of users, and predefined settings. Additionally, one or more artificial intelligence (AI) models may be implemented by the system to analyze waveform and timestamp data to generate pattern segments. The user may retrieve and execute selected segments based on timestamp input. The system may also facilitate connectivity between users to enable interactive control of respective sexual stimulation devices within the interactive platform. Specifically, the system transmits a connectivity request initiated by a user to a creator or another user, and establishes a control connection upon receiving an approval message to realize mutual control of sexual stimulation devices. In further embodiments, the system supports timestamp-based bullet-comment social interaction, where feedback data is associated with specific timestamps to form an interactive record that can be replayed in chronological order, allowing subsequent users to trigger control segments directly from time-synced comments. The system 120 creates one or more virtual rooms in the interactive platform 118. Each virtual room of the one or more virtual rooms is appended with the at least one control pattern including the set of control parameters. The one or more virtual rooms may include a live streaming interaction room, a chat room, a topic-themed chat room, and the like. The system 120 generates a set of virtual room elements for each of the one or more virtual rooms based on the analysis of the set of control parameters of each of the one or more virtual rooms. The set of virtual room elements includes at least one of a background pattern, animations, audio data, and the like. For example, the one or more virtual rooms may be configured with a soft starry sky background (i.e., the background pattern) associated with ambient piano music (i.e., the audio data). The analysis of the control parameters to generate the virtual room elements is performed by a rule-based mapping engine that operates as follows: first, the system extracts statistical features from the control parameter set, including average intensity, intensity variance, dominant frequency, and rhythm regularity. Second, the system applies a pre-configured mapping table that associates feature value ranges with specific virtual room elements. For instance: If the average intensity is less than 30% of maximum and the rhythm regularity is high (cyclic period variation <5%), the system selects a “calm” background theme (e.g., starry sky, gentle flowing water), soft light animations (e.g., twinkling stars with 2-second fade), and ambient music (e.g., piano or nature sound, 40-60 BPM). If the average intensity is between 30% and 70% and the frequency is between 1 Hz and 3 Hz, the system selects a “steady” theme (e.g., abstract geometric patterns, color gradient), rhythmic pulsing animations (synchronized to the dominant frequency), and lounge music (80-110 BPM). If the average intensity exceeds 70% or the intensity variance is high (standard deviation >25% of mean), the system selects a “dynamic” theme (e.g., cyber night club, neon lights), fast-paced animations (e.g., stroboscopic effects, moving particles), and upbeat electronic music (120-150 BPM). Additionally, the system can customize animations by mapping the control pattern's peak timestamps to visual highlight events (e.g., a bright flash at each intensity peak). The mapping rules are stored in a configuration file and can be updated by the platform administrator or, in some embodiments, learned from user preference feedback via a reinforcement learning model. The generated virtual room elements are then stored in the database 116 and served to user devices when the room is accessed.

The present disclosure provides one or more technical advantages, such as the disclosed system provides a technically improved framework for generating and executing control patterns through a structured temporal command architecture. By organizing control parameters as timestamp-associated discrete command sequences, the system enables deterministic device actuation, efficient data representation, reduced transmission overhead, and precise segment-level access without requiring full pattern replay. Further, the feedback-driven update mechanism introduces a closed-loop control refinement process in which user feedback data is processed and mapped to corresponding timestamps to generate updated control parameters. This enables rule-based and context-sensitive modification of control sequences, improving adaptability while maintaining structural integrity of the original pattern. The social feature information-based preview replaces traditional abstract parameter display, allowing users to intuitively perceive control features of the control pattern before execution, which greatly improves user experience.

The virtual room architecture enables synchronized multi-device control through coordinated transmission of control patterns to multiple user devices. Real-time monitoring of room conditions and dynamic generation of modified control parameters allow responsive adaptation of device behavior across distributed users, thereby improving synchronization accuracy and system robustness under varying user participation levels. Further, implementation of artificial intelligence (AI) models for waveform analysis and timestamp-based segmentation provides automated structural identification of control pattern segments. This reduces manual configuration complexity, enables selective segment retrieval, and improves computational efficiency for preview and partial execution scenarios. The interactive record generated based on timestamped feedback realizes synchronous replay of feedback and control patterns, forming a complete social interaction closed loop for the control pattern.

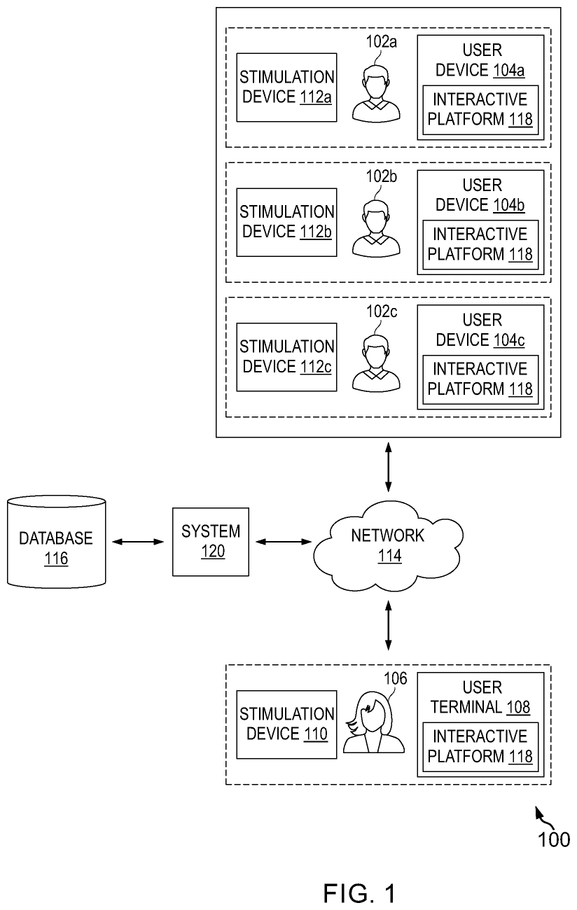

Various embodiments of the present disclosure are described hereinafter with reference to FIG. 1 to FIG. 7.

FIG. 1 illustrates an example representation of an environment 100 related to at least some example embodiments of the present disclosure. Although the environment 100 is presented in one arrangement, other arrangements are also possible where the parts of the environment 100 (or other parts) are arranged or interconnected differently. The environment 100 generally includes a plurality of users, such as a user 102a, a user 102b, and a user 102c. For description purposes, only three users are shown, however, there can be any number of users. The users 102a-102c are collectively referred to as the plurality of users 102 or the users 102. Each of the users 102a, 102b, and 102c is associated with a user device 104a, a user device 104b, and a user device 104c, respectively. The user devices 104a-104c may include at least a laptop computer, a phablet computer, a handheld personal computer, a netbook, a Web book, a tablet computing device, a smartphone, or other mobile computing devices.

Further, the environment 100 includes a creator 106. In an embodiment, the creator 106 may be a user of the plurality of users 102. For illustration purposes, only a single creator is depicted in FIG. 1, however, there can be any number of creators. The creator 106 is associated with a user terminal 108. The user terminal 108 may include at least a laptop computer, a phablet computer, a handheld personal computer, a virtual reality (VR) device, a netbook, a Web book, a tablet computing device, a smartphone, or other mobile computing devices. The creator 106 may be users who perform a set of interactive inputs (e.g., comments, likes, audio, video, text, artificial intelligence tags, and the like) related to sexual activities in an interactive platform 118. The interactive inputs of the creator 106 are used to generate social feature information, which forms part of the interactive contents associated with the control pattern.

Furthermore, the creator 106 is associated with at least one sexual stimulation device 110. Additionally, the users 102a-102c are associated with at least one sexual stimulation device 112a, at least one sexual stimulation device 112b, and at least one sexual stimulation device 112c, respectively. The sexual stimulation device 110 and the sexual stimulation devices 112a-112c may include, but are not limited to, adult toys, sensory sexual stimulation devices, interactive feedback devices, remote-controlled or network-connected devices, control terminals, peripheral devices, and the like. The sexual stimulation device 110 and the sexual stimulation devices 112a-112c may be connected wirelessly with the respective user terminal 108 and user devices 104a-104c. Some examples of the wireless connectivity for enabling connection may include, but are not limited to, near field communication (NFC), wireless fidelity (Wi-Fi), Bluetooth, Zigbee, and the like.

Various entities in the environment 100 may connect to a network 114 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. In some instances, the network 114 may include a secure protocol (e.g., Hypertext Transfer Protocol (HTTP)), and/or any other protocol, or set of protocols. In an example embodiment, the network 114 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof.

The environment 100 further includes a system 120. The system 120 may be embodied in at least one computing device in communication with the network 114. The system 120 is configured to host and manage the interactive platform 118. The interactive platform 118 may be equipped in the user terminal 108 and the user devices 104a-104c. The interactive platform 118 may be a cloud hosting platform, a cloud streaming platform, or a software as a service (SaaS) based hosting platform, or any other hosting platform. The system 120 may be embodied in at least one computing device in communication with the network 114. The system 120 may be specifically configured, via executable instructions, to perform one or more of the operations described herein. In general, the system 120 is configured to generate at least one control pattern to operate the at least one of the sexual stimulation device 110 and the sexual stimulation devices 112a-112c, which will be explained further in detail. The system 120 is further configured to maintain interactive contents, generate interactive records based on timestamped feedback, and process user connectivity requests for mutual device control.

Further, one or more components of the interactive platform 118 may be stored in a database 116 associated with the system 120. The interactive platform 118 is a set of computer-executable codes configured to manage the at least one control pattern to operate the sexual stimulation devices (e.g., operating sexual stimulation devices to provide stimulations). In one embodiment, the interactive platform 118 may be accessed as a web-based application on the user terminal 108 and the user devices 104a-104c. In some embodiments, the interactive platform 118 may be hosted by one or more third-party interactive platforms (not shown in figures) and communicably coupled to the network 114. In some embodiments, the user terminal 108 and the user devices 104a-104c may access an instance of the interactive platform 118 from the system 120 for installing on the user terminal 108 and the user devices 104a-104c using application stores associated with operating systems such as Apple IOS, Android OS, Google Chrome OS, Symbian OS, Windows Mobile OS, and the like.

In an embodiment, the database 116 may be a centralized repository configured to store one or more control patterns. In one embodiment, the set of control parameters is defined based on the set of interaction inputs performed by the creator 106 and/or the users 102 through the interactive platform 118, and the system 116 further stores a set of interactive contents associated with each control pattern, wherein the interactive contents include social feature information generated from the interaction inputs and characterizing the control features of the control pattern. The set of interaction inputs may include a comment content, number of likes, room background, and the like. The set of control parameters may include data related to intensity, rhythm, stimulation, and the like. The at least one control pattern may operate the at least one sexual stimulation device 110 of the creator 106 and/or the user. The database 116 also stores interactive records generated by associating timestamped feedback data with the control pattern timeline. The database 116 also stores a set of interactive contents associated with each control pattern, each interactive content comprising social feature information (e.g., comments, like counts, popularity tags, virtual room elements) that characterizes the control features (e.g., intensity, rhythm, dynamic changes) of the corresponding control pattern. The social feature information is generated based on interaction inputs performed by creators or other users on the platform.

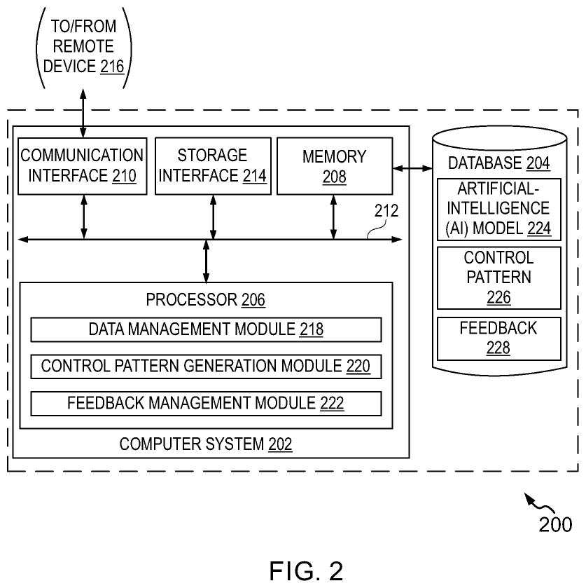

In another embodiment, the set of control parameters is defined by one or more Artificial Intelligence (AI) models (see, 224 in FIG. 2). The set of control parameters corresponds to a temporal discrete command sequence. Each control parameter of the at least one control pattern corresponding to the temporal discrete command sequence is arranged in a sequential manner based at least on a timestamp associated with each control parameter of the set of control parameters. In other words, the set of control parameters includes a plurality of time-indexed command entries, where each command entry includes a timestamp and one or more actuator control values for the sex toy (such as the sexual stimulation device 110, and the sexual stimulation devices 112a-112c). The command entries are ordered chronologically and collectively define the operational behavior of the sex toy over a defined duration. During execution, the system 120 processes the command entries sequentially according to their timestamps and generates drive signals for one or more actuators. Further, intermediate control values between adjacent command entries may be determined using interpolation algorithms to produce smooth transitions while maintaining the discrete time-based structure of the command sequence. The social feature information is bound to the control parameters and arranged in the same chronological order as the temporal discrete command sequence.

The system 120 receives a request from the user 102a of the plurality of users 102 to access the set of interactive contents associated with the at least one control pattern. In particular, the user 102a may browse the at least one control pattern and corresponding interactive contents stored in the interactive platform 118 to operate the at least one sexual stimulation device 112a of the user 102a. Further, in response to the request, the system 120 renders the set of interactive contents associated with the at least one control pattern on the user device 104a of the user 102a, wherein the rendered interactive contents enable a preview of at least a portion of the control features of the control pattern. For example, the system 120 may render the social feature information (including intensity, rhythm, comments, likes) in the interactive platform 118 for the user 102a. The rendering of the interactive contents may include a timeline-based preview, a socialized preview, a static preview, and the like. In the timeline-based preview the set of control parameters and corresponding social feature information are decomposed sequentially and represented as a function of time. For example, the intensity values are time-stamped and recorded at discrete time intervals throughout the duration of the operation. In the socialized preview, the system 120 transmits the set of interactive contents of the at least one control pattern to the user device 104a of the user 102a. In the socialized preview, the user device 104a renders the interactive contents to ensure the preview representation of the control features. The preview may include presentation of social feature information and/or timeline-based indicators (i.e., the set of interaction inputs) corresponding to the control pattern. In some embodiments, the transmitted interactive contents enable selective playback or segment-based preview without immediately initiating full device execution. In the static preview, the system 120 renders the comments, number of likes, popularity tags, and social feature information on the user device 104a of the user 102a. The rendered information in the static preview provides a non-time-based summary of user feedback and control features associated with the control pattern. This enables the user 102a to evaluate general characteristics and overall reception of the control pattern without initiating timeline playback or device execution. The system 120 transmits the rendered interactive contents to the user device 104a for display in real-time.

Furthermore, the user 102a may transmit an interactive instruction to access the at least one control pattern stored in the interactive platform 118. Thereafter, the system 120 transmits the at least one control pattern associated with the set of control parameters to the user device 104a of the user 102a in response to receipt of the interactive instruction. The at least one control pattern operates the at least one sexual stimulation device 112a of the user 102a to perform a set of actions for providing stimulation to the user 102a. For example, the at least one control pattern transmitted by the system 120 may operate the sexual stimulation device 112a to perform the set of actions such as vibrations, electric stimulus, actuations, and the like.

In one embodiment, the system 120 may allow the user 102a to provide feedback data related to the at least one control pattern operating the at least one sexual stimulation device 112a of the user 102a. The user 102a may transmit the feedback data to the system 120 through the interactive platform 118 equipped in the user device 104a. Further, the system 120 receives the feedback data from the user 102a based on the operation of the at least one sexual stimulation device 112a using the at least one control pattern including the set of control parameters. The feedback data may include comments, likes, texts, audio, video, and the like. Each piece of feedback data is attached with a timestamp corresponding to the control pattern timeline.

Further, the system 120 generates a set of updated interactive contents corresponding to the feedback data of the user 102a. The feedback data and updated interactive contents are updated according to the timestamp of the at least one control pattern operated using the at least one sexual stimulation device 112a of the user 102a. The feedback data may include comments, ratings, audio notes, and the like. In one embodiment, the at least one control pattern operating the at least one sexual stimulation device 112a may reach the expectations of the user 102a. The user 102a may provide feedback data as good or excellent (e.g., comments). The system 120 generates the set of updated interactive contents based on the received feedback data from the user 102a. In another embodiment, the at least one control pattern operating the at least one sexual stimulation device 112a may not reach the expectations of the user 102a. The user 102a may provide feedback data as average or poor (e.g., comments). The system 120 generates the set of updated interactive contents based on the received feedback data from the user 102a.

The system 120 creates one or more virtual rooms in the interactive platform 118. Each virtual room of the one or more virtual rooms is appended with the at least one control pattern including the set of control parameters. The one or more virtual rooms may include a live streaming interaction room, a chat room, a topic-themed chat room, and the like. The system 120 generates a set of virtual room elements for each of the one or more virtual rooms based on the analysis of the set of control parameters of each of the one or more virtual rooms. The set of virtual room elements includes at least one of a background pattern, animations, audio data, and the like. For example, the one or more virtual rooms may be configured with a soft starry sky background (i.e., the background pattern) associated with ambient piano music (i.e., the audio data). The virtual room elements are dynamically adjusted based on the control features of the control pattern attached to the virtual room.

The user 102a may request the system 120 to access a virtual room of the one or more virtual rooms. The system 120 may facilitate accessing the virtual room through the interactive platform 118. Further, the system 120 transmits the at least one control pattern including the set of control parameters to the users 102 accessing the virtual room of the one or more virtual rooms. The at least one control pattern including the set control parameters, operates the at least one sexual stimulation device 112a-112c of the respective users 102 accessing the virtual room.

Furthermore, the system 120 selectively augments the set of updated interactive contents to the original interactive contents corresponding to the at least one control pattern based on one or more rules. The one or more rules may include analyzing the temporal command sequence and a correlation of the feedback data from at least one of the users 102 and the creator 106. The system 120 may receive real-time feedback data from the user 102a. The feedback data inherently carries precise timestamps. The integration of the feedback data from the user 102a with the feedback data from the creator may include aggregation calculations of the corresponding feedback data, recognition of the at least one control pattern, intelligent presentation of the feedback data, and the like. The system 120 selectively augments the integrated feedback data (i.e., the set of updated interactive contents) to the original interactive contents stored in the interactive platform 118. Additionally, the system 120 analyzes the temporal distribution and correlation of the feedback data. Further, the system 120 constructs a heatmap indicative of quality and a community consensus description for the feedback data. This analysis provides the users 102 with a time-dimensional decision-making references for previewing the at least one control pattern. In an embodiment, the system 120 builds a complete data loop to evaluate the feedback data. The system 120 automatically updates the status of the at least one control pattern operating the at least one sexual stimulation device 112a of the user 102a. The status may indicate completion, pause, exited, number of repetitions, and the like. The system 120 also generates an interactive record by associating the timestamped feedback data with the control pattern timeline, and replays the interactive record synchronously when a user browses the control pattern.

The number and arrangement of systems, devices, and/or networks shown in FIG. 1 are provided as an example. There may be other systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices.

FIG. 2 illustrates a simplified block diagram of a system 200 facilitating adult entertainment, in accordance with an embodiment of the present disclosure. Examples of the system 200 may include, but are not limited to, the system 120 as shown in FIG. 1. The system 200 includes a computer system 202 and a database 204. The computer system 202 includes at least one processor 206 for executing instructions, a memory 208, a communication interface 210, and a storage interface 214. The one or more components of the computer system 202 communicate with each other via a bus 212.

In one embodiment, the database 204 is integrated within the computer system 202 and configured to store an instance of the interactive platform 118 and one or more components of the interactive platform 118. In addition, the database 204 is configured to store media content, control parameters for operating sexual stimulation devices, interaction elements, and the like. The computer system 202 may include one or more hard disk drives as the database 204. The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The database 204 may include a control pattern 226 to store the at least one control pattern including the set of control parameters. Further, the database 204 includes one or more artificial intelligence (AI) models 224 to analyze the at least one control pattern and perform one or more operations such as tag generation, segmentation, and the like. Furthermore, the database 204 includes feedback 228 to store the feedback data from at least one of the user 102 and the creator 106. The AI models 224 may be trained using a training dataset comprising historical control parameter sets, associated social feature information, timestamped feedback records, user ratings, engagement metrics, and derived heatmap distributions stored in the feedback database 228. The training dataset may include labeled data indicating segment boundaries, emotion tags, intensity classifications, and user preference patterns, enabling supervised and/or semi-supervised training. The AI models 224 are periodically retrained or fine-tuned using newly accumulated feedback data 228 to improve accuracy in pattern analysis, tag generation, and segment identification. In some embodiments, the AI models 224 may be trained using supervised, unsupervised, and/or semi-supervised learning techniques.

The processor 206 includes suitable logic, circuitry, and/or interfaces to execute computer-readable instructions. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the system 200, as described herein. In some embodiments, the memory 208 may be realized in the form of a database or cloud storage working in conjunction with the system 200, without deviating from the scope of the present disclosure.

The processor 206 is operatively coupled to the communication interface 210 such that the processor 206 is capable of communicating with a remote device 216, such as the user devices 104a-104c, the user terminal 108, the sexual stimulation device 110, the sexual stimulation devices 112a-112c, or with any entity connected to the network 114 as shown in FIG. 1.

It is noted that the system 200 as illustrated and hereinafter described is merely illustrative of an apparatus that could benefit from embodiments of the present disclosure and, therefore, should not be taken to limit the scope of the present disclosure. It is noted that the system 200 may include fewer or more components than those depicted in FIG. 2.

In one embodiment, the processor 206 includes a data management module 218, a control pattern generation module 220, and a feedback management module 222. The processor 206 may include other engines apart from those depicted in FIG. 2, therefore, it should not be taken to limit the scope of the present disclosure. The processor 206 further comprises a connection management module configured to process user connectivity requests and establish mutual control connections for sexual stimulation devices.

The data management module 218 includes suitable logic and/or interfaces to manage the at least one control pattern of the interactive platform 118. The data management module 218 receives the set of interaction inputs from at least the creator 106 through the interactive platform 118. The system 200 generates the at least one control pattern including the set of control parameters based on the set of interaction inputs of the creator 106. The set of interaction inputs corresponds to the metadata layer being appended with the at least one control pattern. The metadata layer appended to the at least one control pattern is used to describe, evaluate, and categorize their associated experiences. The data management module 218 store the at least one control pattern including the set of control parameters in the database 204. The set of control parameters may include a keyframe sequence for the vibration intensity in the at least one sexual stimulation device 112a of the user 102a. For example, at time interval 0.0 seconds, the vibration intensity is 1. At time interval 1.0 seconds, the vibration intensity is 1. At time interval 1.1 seconds, the vibration intensity is 0. At time interval 2.0 seconds, the vibration intensity is 2, and so on. In one example scenario, the system 200 may generate an advanced pattern (e.g., the at least one control pattern), such as a symphony to control two independent vibration motors, such as a vibrator A and a vibrator B, associated with the at least one sexual stimulation device 112a. For instance, the vibrator A may include keyframes to increase and/or decrease the intensity and frequency of the peak gradually using a sine wave. The vibrator B may include keyframes to increase and/or decrease the intensity and the frequency to the peak gradually using a cosine wave.

In one embodiment, the creator 106 may request the system 200 to transmit the at least one control pattern to the user terminal 108 to operate the at least one sexual stimulation device 110 of the creator 106. The creator 106 may provide the feedback data based on the actions performed by the at least one sexual stimulation device 110 corresponding to the at least one control pattern. The system 200 may store the at least one control pattern and the feedback data received from the creator 106 related to the at least one control pattern is stored in the database 204 as described above. The system 200 generates an interactive record by associating the creator's timestamped feedback data with the control pattern timeline.

In one embodiment, the system 200 may receive the request from the users 102 to access the set of control parameters associated with the at least one control pattern stored in the database 204. The system 200 may transmit the set of control parameters associated with the at least one control pattern to the user device 104a for preview. The user 102a may preview the at least one control pattern based on the set of control parameters rendered on the user device 104a. The set of control parameters may include a timestamp for each action, intensity, frequency, waveform, and the like. In case, the user 102a requires the at least one control instruction upon previewing the set of control parameters, the user 102a may transmit the interactive instruction to the system 200 to access the at least one control pattern. Thereafter, the system 200 transmits the at least one control pattern, including the set of control parameters, to the user device 104a of the user 102a. The control pattern generation module 220 includes suitable logic and/or interfaces to generate the at least one control pattern in the interactive platform 118. The control pattern generation module 220 generates the at least one control pattern based on the set of interaction inputs of the creator 106 and/or the user 102a. As described above, the set of interaction inputs may include comments, likes, input related stimulation, and the like. Thus, it is apparent that the set of interaction inputs received by the creator 106 and/or the users 102 corresponds to explicit user-contributed data. The explicit user-contributed data may be utilized to create the set of control parameters for the at least one control pattern. The system converts these interaction inputs into social feature information that characterizes the control features of the pattern. For example, a comment “extremely intense” indicates high vibration intensity, and such comment becomes part of the interactive content item for that pattern. In an embodiment, the explicit user-contributed data corresponds to the feedback data, which will be utilized to update the set of control parameters of the at least one control pattern. The set of interaction inputs may include a user identifier (ID) of a user, such as the creator 106, a pattern identifier (ID) of the at least one control pattern stored in the database 204, and the timestamp related to the set of interactive inputs. The set of interactions is converted into create, read, update, and delete (CRUD) operations by the interactive platform 118. For example, the user M (e.g., the creator 106) may provide an input (i.e., the set of interaction inputs) as “Feels like lying by the window listening to the rain, very relaxing” associated with an “Afternoon Drizzle” in the interactive platform 118. The system 200 generates a Hypertext Transfer Protocol (HTTP) request in the interactive platform 118. The HTTP request may include the pattern ID, the user ID and the corresponding set of interactive inputs. Further, the system 200 validates the HTTP request to generate the at least one control pattern as a new record in the interactive platform 118. The at least one control pattern may be associated with the user ID of the creator 106, the pattern ID of the at least one control pattern, and the timestamp of the set of interactive inputs.

In another embodiment, the system 200 may use implicit data generation to generate the at least one control pattern. In this scenario, the system 200 may periodically aggregate the number of likes and implement Natural Language Processing (NLP) technique to analyze the set of interactive inputs of the users 102 to generate one or more emotional tags. Upon continuous monitoring, the system 200 generates the at least one control pattern based on the system-defined data. Thus, it is apparent that the system 200 generates implicit data by processing raw behavioral data collected during creation, preview, and execution of the at least one control pattern. Additionally, the system 200 may perform aggregation operations, statistical analysis, and/or machine learning-based processing on interaction records, playback behavior, completion rates, replay frequency, timestamped feedback density, and sentiment analysis results. The feedback management module 222 includes suitable logic and/or interfaces to manage the feedback data from the users 120 based on the operation of the at least one control pattern. For instance, the user 102a may provide the feedback data related to the at least one control pattern operating in the sexual stimulation device 112a of the user 102a. In one example, the system 200 receives the feedback data from the user 102a. In another example, the system 200 receives the feedback data from the creator 106, or any other user using the interactive platform 118. The feedback data may include comments, likes, texts, audio, video, ratings, and the like. Thus, it is apparent that the feedback data received by the users (such as the creator 106 and/or the users 102) of the interactive platform 118 corresponds to explicit user-feedback data. The explicit user-feedback data may be collected using one or more feedback methods, such as a set of questions related to the operation of the at least one control pattern, ratings related to the operation of the at least one control pattern, textual data, audio notes, comments, tags, animations (such as emojis), and the like. For example, the user 102a experiences the at least one control pattern, such as “Morning Awakening” pattern. The interactive platform 118 automatically pops up a minimalist feedback overlay (i.e., the set of questions), including queries, such as “How was it?” with three emoji options and a row of optional tags “Too Mild,” “Just Right,” “Too Intense”. In this example scenario, the user 102a may select one of the emojis and the tags (e.g., “Just Right”). The selected two data points are immediately uploaded to update the pattern's emotional tendency statistics and the count for the intensity suitability tag, respectively. In another aspect, the feedback data includes timestamp-specific bullet comments, voice notes, or emotion tags. The system associates each piece of feedback with a corresponding timestamp on the pattern's timeline to generate an interactive record (e.g., a bullet-comment thread) that can be replayed in chronological order when the pattern is used or previewed.

In another embodiment, the system 200 (or the feedback management module 222) may be configured to automatically log the set of interactions of the user 102a during the operation of at least one control pattern in the at least one sexual stimulation device 112a of the user 102a. Herein, the tracking of the set of interactions corresponds to the feedback data. The feedback data tracked by the feedback management module 222 may include, for example, the completion, pausing, or repeating the operations of the at least one control pattern using the sexual stimulation device 112a of the user 102a. In some embodiments, the feedback management module 222 utilizes a contextual in-depth feedback technique to collect the feedback data from the user 102a. In particular, the system 200 collects the real-time feedback data, such as audio, graphical representation data, comments, and the like, during the execution of the at least one control pattern in the at least one sexual stimulation device 112a of the user 102a. Herein, the tracking of the feedback data by the system 200 corresponds to implicit behavioral feedback extraction. For example, the user 102a pauses playback of the at least one control pattern “Epic Saga (20 minutes)” at the 8 minute 15 second mark and completely exits playback 30 seconds later. The system 200 logs the user interactions in the database 204. Further, when a significant number of users abandon playback around a similar time point (e.g., 8-9 minutes), the system 200 may flag that this pattern may have a “drop-off point”. The creator 106 can receive an anonymized report stating “Your pattern has a higher user drop-off rate around the 8-9 minute mark. When a subsequent user submits new feedback during replay, the system updates the interactive record by adding the new feedback with its timestamp, thereby creating an updated record that reflects multi-user co-creation.

Further, the feedback data, whether explicit user-contributed data or system-tracked behavioral data, is converted into an anonymized form within the interactive platform 118 prior to storage or further processing. In particular, personally identifiable information (PII) associated with a submitting user (such as the user 102a) is removed, masked, hashed, tokenized, or replaced with a platform-generated identifier (such as the user identifier (ID) of the user 102a in the interactive platform 118). Hence, the feedback data of the user 102a is not directly traced to the individual user in the interactive platform 118. The feedback data, after anonymization or secure association with an internal user identifier, is stored in the database 204 and bound to a corresponding pattern identifier (the pattern ID). In this manner, the feedback data is logically linked to the at least one control pattern while preserving user privacy.

The system 200 generates the set of updated control parameters corresponding to the feedback data through the explicit user-contributed data or the system-tracked behavioral data. Thereafter, the feedback management module 222 selectively augments the set of updated control parameters to the at least one pattern, including the set of control parameters based on one or more rules and a corresponding timestamp of the at least one control pattern. In particular, the feedback management module 222 analyzes the correlation between the set of control parameters of the at least one control pattern and the feedback data received from a user, such as the user 102a of the interactive platform 118. Also, the feedback management module 222 may perform correlation analysis of the feedback data received from multiple users (such as the users 102a and 102b) of the interactive platform 118. Upon performing correlation analysis, the feedback management module 222 may selectively filter the feedback data to eliminate duplication, and generate the set of updated control parameters for augmenting the at least one control pattern, including the set of control patterns. Additionally, the feedback management module 222 augments the set of updated control parameters with the at least one control pattern, including the set of control patterns based on a corresponding timestamp of the at least one control pattern. Hence, it is understood that the one or more rules correspond to temporal distribution and the correlation of the feedback data from at least the users 102, the creator 106, and/or the system tracked data through the interactive platform 118. Similarly, the user 102b may provide the feedback data based on operating the at least one control pattern in the at least one sexual stimulation device 112b of the user 102b. The system 200 generates the set of updated control parameters based on the feedback data of the user 102b. The system 200 selectively augments the set of updated control parameters to the at least one control pattern including the set of control parameters stored in the database 204 of the system 200. For example, when the user 102b previews the control pattern, on the timeline preview view. In this example, the control pattern may be updated due to the feedback data from the user 102a. Further, the user 102b may notice a distinct brightly highlighted area around 03:10 minutes, with a hover tooltip indicating “237 user feedback concentrated here”. The user 102b may click on it to browse specific comments like “The flickering sensation is wonderful!” or “Like stars blinking”. This preview gives the user 102b a precise expectation of the pattern's “highlight moments” before experiencing it.

In an embodiment, the control pattern generated by implementing the AI models 224 may be automatically adjusted based on the feedback data from users, such as the users 102 and/or the creator 106. The system 200 may automatically adjust the intensity or rhythm of corresponding segments in the at least one control pattern, thus enabling such segments to better align with the preferences of the majority, achieving “community optimization” of the control pattern.

In some embodiments, the feedback data received from at least the users 102 and the creator 106 may be in the form of one or more bullet comments, one or more time-synced audio notes, or in any format as per the requirements. Each feedback data is associated with a timestamp. The system 200 generates the set of updated control parameters based on the feedback data (e.g., the one or more bullet comments, or the one or more time-synced audio notes). The set of updated control parameters is augmented to the at least one control pattern including the set of control parameters as described above.

In some embodiments, the at least one pattern may include one or more segments based on the request by at least the users 102 and the creator 106. The one or more segments may include a segment A, a segment B, a segment C, and a segment D. In an embodiment, the system 200 generates the one or more segments of the at least one control pattern based on implementing the artificial intelligence (AI) models 224. The AI models 224 are configured to generate the one or more segments in the at least one control pattern based on analyzing a waveform of the at least one control pattern and the set of control parameters and associated timestamp of each control parameter of the set of control parameters of the at least one control pattern. The AI models 224 are further configured to analyze the waveform and the feedback data (e.g., bullet comments containing keywords like “climax”, “build-up”) to automatically segment the control pattern into regions such as an onboarding phase, escalation phase, peak phase, and resolution phase. The system may also generate usage reports summarizing a user's interaction with each segment. In one embodiment, the system 200 may analyze the waveform of the at least control pattern using the pattern partitioning technique. The pattern partitioning technique may enable the partitioning of the at least one control pattern as time-based segments. In another embodiment, the AI models 224 associated with the system 200 may implement sentiment analysis, contextual analysis, natural language processing, or any other analysis technique to analyze the feedback data (e.g., the comments, text, audio notes, and the like) received from at least the users 102 and the creator 106 for generating the one or more segments of the at least one control pattern. For example, the user 102a plays the at least one control pattern for 10 minutes. The AI models 224 analyzes the waveform, comments related to the at least one control pattern to generate the segment at 2 minutes as climax zone. In one example, the one or more segments of the at least one control pattern may include a segment A, a segment B, a segment C, and a segment D. The segments A, B, C, and D may correspond to an onboarding phase, an escalation phase, a peak phase and a resolution phase, respectively, in the at least one control pattern. It is to be noted that, for illustrative purposes, only four segments are described, however, there may be any number of segments.

In an embodiment, the system 200 generates the one or more segments of the at least one control pattern based on implementing the artificial intelligence (AI) models 224. The AI models 224 are configured to generate the one or more segments in the at least one control pattern based on analyzing a waveform of the at least one control pattern and the set of control parameters and associated timestamp of each control parameter of the set of control parameters of the at least one control pattern. Specifically, the AI model 224 is implemented as a deep neural network with a temporal sequence processing architecture, such as a bidirectional Long Short-Term Memory (LSTM) network or a Transformer encoder. The input to the model is a feature matrix constructed from the control parameter sequence: each time step t includes normalized intensity, frequency, and second-order derivatives (acceleration of intensity change). Optionally, the model also receives an embedding vector representing user feedback (e.g., keyword embeddings from bullet comments like “climax”, “build-up”, “calm”). The model is trained, using supervised learning, on a training dataset of control patterns whose segment boundaries have been manually annotated by human experts. The training objective is to predict, for each time step, a probability of being a segment boundary (onset of a new phase). A post-processing step (e.g., peak detection with a minimum distance constraint) converts these probabilities into final segment timestamps. The model further classifies each segment into one of predefined types (e.g., “onboarding”, “escalation”, “peak”, “resolution”) by adding a softmax classification head. In an alternative embodiment, the system uses unsupervised clustering of the control parameter sequence based on dynamic time warping similarity to discover natural segments without requiring labeled training data. In both implementations, the resulting segments are stored as metadata associated with the control pattern, enabling users to preview or jump to specific portions. The AI models 224 are further configured to analyze the waveform and the feedback data (e.g., bullet comments containing keywords like “climax”, “build-up”) to automatically segment the control pattern into regions such as an onboarding phase, escalation phase, peak phase, and resolution phase. The system may also generate usage reports summarizing a user's interaction with each segment.

In some embodiments, the user 102a may request the system 200 to preview the at least one pattern. The system 200 renders the set of control parameters of the at least one control pattern, for example, in the form of bullet comments (such as the segment A, the segment B, the segment C, and the segment D), to the user 102a. The user 102a may preview the at least one control pattern and request the system 200 to access a segment among the one or more segments of the at least one control pattern. In one embodiment, the user 102a may request the system 200 through the interactive platform 118, to access the segment C (i.e., the peak phase) of the at least one control pattern. The request may include an input related to the timestamp of the segment, such as the segment C of the at least one control pattern. The system 200 retrieves the segment of the at least one control pattern and associated control parameter of the segment, such as the segment C from the set of control parameters of the at least one control pattern based on the timestamp of the segment C of the at least one control pattern. Thereafter, the system 200 may transmit the segment C (i.e., the peak phase) of the at least one control pattern to the user 102a, for enabling the user 102a to control the at least one sexual stimulation device 112a based on the segment C. The segment C operates the peak phase (e.g., the climax) of the at least one control pattern in the at least one sexual stimulation device 112a. Similarly, the creator 106 and/or the users 102b-102d may selectively request the system 200 to access the one or more segments of the at least one control pattern. Thus, the system enables the user to request a specific segment by providing a timestamp input, retrieves the subset of control parameters corresponding to that timestamp (e.g., from 1:15 to 1:25), and transmits only that segment to the user device, allowing the stimulation device to execute only the selected portion of the pattern.

Further, the system 200 may receive a request from the users 102 to access the virtual room of the one or more virtual rooms of the interactive platform 118. The system 200 facilitates the plurality of users 102 to access the virtual room of the one or more virtual rooms through the interactive platform 118. The system 200 transmits the at least one control pattern including the set of control parameters associated with the virtual room, to each of the plurality of users 102 of the virtual room. The at least one control pattern including the set of control parameters associated with the virtual room, allows synchronous control of the at least one sexual stimulation device 112a-112c of each of the plurality of users 102 in the virtual room. The system 200 may use a buffer mechanism to buffer the at least one control pattern including the set of control parameters, based on the network jitter of the user devices 104 of the respective users 102. The buffering mechanism allows the at least one sexual stimulation device 112a-112c of the users 102 to operate in a synchronous manner. For example, the system 200 generates a party room (i.e., the virtual room) in the interactive platform 118. The party room may include 50 party participants (e.g., the users 102) connected concurrently. The system 200 acting as a master clock transmits at least one control pattern including the set of control parameters to the participants (i.e., the users 102) simultaneously through the interactive platform 118 equipped in the user devices 104 of the users 102 to operate the adult toys (e.g., the at least one sexual stimulation device 112a-112c) of the participants synchronously. Additionally, the participants of the virtual room may join the virtual room at different timestamps. In this scenario, the system 200 ensures that the at least one control pattern is transmitted to the participants joining at different timestamps according to the timestamp of each participant joining the virtual room, thereby allowing synchronous control for all the participants of the virtual room.

Furthermore, the system 200 monitors one or more conditions associated with the virtual room in real-time. The one or more conditions may include the feedback data, a number of users in the virtual room, and predefined settings defined by the creator 106 of the virtual room. In one embodiment, the feedback data may be explicit feedback generated by the users 102 and the creator 106. The users 102 and/or the creator 106 accessing the virtual room may provide the feedback data based on operating the corresponding sexual stimulation devices 112a-112c and at least one sexual stimulation device 110 using the at least one control pattern. The system 200 may dynamically generate a modified set of control parameters for the at least one control pattern associated with the virtual room corresponding to the one or more conditions in real-time. For example, the virtual room initially includes two participants (e.g., the user 102a and the user 102b). The system 200 may provide the at least one control pattern having a low intensity to the user 102a and the user 102b. Further, the system 200 recognizes the request from the 50 participants (i.e., the user 102c). The system 200 allows the user 102c to access the virtual room. In this scenario, the system 120 analyzes the number of participants in the virtual room and modifies the set of control patterns included in the at least one pattern associated with the virtual room. In particular, the system 200 dynamically generates a set of modified control parameters for the at least one control pattern associated with the virtual room corresponding to the one or more conditions. Thereafter, the system 200 transmits the at least one control pattern including the set of modified control parameters, to each of the users 102a-102c of the virtual room. This enables synchronous control of the corresponding at least one sexual stimulation device 112a-112c of each of the users 102a-102c in the virtual room based on the at least one control pattern including the set of modified control parameters. In a further example, when the number of participants increases from 2 to 50, the system may automatically increase the intensity or rhythm of the control pattern. If users submit aggregated feedback such as comments “boring”, the system uses NLP to adjust the pattern accordingly. The dynamic modification is performed by a real-time condition-response engine implementing a set of deterministic or heuristic rules, examples of which include: User count mapping: The system maintains a baseline intensity value (e.g., 40% of maximum). When the number of users N in the virtual room changes, the intensity scaling factor S is computed as S=min(2.0, 1+0.02×(N−N0)) for N>N0, where N0 is a reference count (e.g., 10). Similarly, the vibration rhythm (frequency) is increased by a factor of 1+0.01×(N−N0), capped at 2.0. If N falls below N0, the intensity and rhythm are scaled down linearly but not below 0.5× baseline. Feedback sentiment adjustment: The system aggregates textual feedback from users in the room using a lightweight NLP sentiment classifier (e.g., a pre-trained DistilBERT model or a lexicon-based VADER tool). If the dominant sentiment score exceeds a positive threshold (e.g., >0.7), the intensity is increased by 5%; if the sentiment score falls below a negative threshold (e.g., <0.3), the intensity is decreased by 5% and the rhythm is gradually slowed by decreasing the playback speed to 0.95×. For specific keyword triggers (e.g., “faster”, “stronger”, “boring”, “too slow”), the system applies predefined delta changes: keyword “faster” increases rhythm by 10%; “stronger” increases intensity by 10%; “boring” decreases intensity by 15% and speeds up transition to the next pattern segment. Predefined settings by room creator: The creator can define a rule configuration via the interactive platform, such as “if number of users >20, switch to high-intensity version of pattern B” or “if any user says ‘quiet’, mute background audio for 30 seconds”. These rules are stored in a JSON format and interpreted by the engine. All modified control parameters are generated by applying the scaling factors and deltas to the original parameter set, while preserving the temporal structure (timestamps). The engine recalculates modifications periodically (every 5 seconds) or upon a significant change in any monitored condition. This ensures that the haptic experience adapts to the evolving social dynamics of the virtual room in a predictable and transparent manner. In a further example, when the number of participants increases from 2 to 50, the system may automatically increase the intensity or rhythm of the control pattern. If users submit aggregated feedback such as comments “boring”, the system uses NLP to adjust the pattern accordingly.

In one example scenario, the participants (i.e., the users 102) of the virtual room may provide feedback data to modify the at least one control pattern. For example, the users 102 may provide one or more comments as “boring” in response to the operation of the at least one control pattern including the set of control parameters or the set of modified control parameters. The system 200 (or the AI models 224) analyzes the comments using the Natural Language Processing (NLP) technique to generate the set of modified control parameters. In another example scenario, the system 200 may render a voice bullet interface to receive the feedback data (i.e., voice or audio) from the users 102 in the virtual room. In this example scenario, the system 200 may analyze the audio data (for example, by implementing sentiment analysis and audio processing techniques) to determine the tone of voice feedback (i.e., the feedback data) of the users 102 in the virtual room. The one or more AI models 224 of the system 200 analyze the tone of the voice feedback to modify the at least one control pattern for controlling the at least one sexual stimulation device 112a-112c of the users 102. In one scenario, the user 102a may provide the voice feedback in a high tone. The system 200 modifies the at least one control pattern to operate the at least one sexual stimulation device 112a of the user 102a at high intensity. In another scenario, the user 102b may provide the voice feedback in a low tone. The system 200 modifies the at least one control pattern to operate the at least one sexual stimulation device 112b of the user 102b at low intensity. Further, the system 200 analyzes the feedback data and the number of feedback data provided by the users 102 to modify the set of control parameters of the at least one control pattern. The system 200 transmits the at least one control pattern including the set of modified control parameters to each of the plurality of users 102 of the virtual room.

In some embodiments, the user 102a may operate the virtual room using an offline mode within the interactive platform 118. In this scenario, the system 200 automatically downloads (or caches) the set of virtual room elements (such as the background pattern, the audio data, animations, and the like) and stores in a storage device associated with the user device 104a. This allows the user 102a to access the virtual room to operate the at least one sexual stimulation device 112a regardless of the internet connectivity of the user device 104a.

Further, the system 200 may allow the users 102 and the creator 106 to define one or more privacy configurations for at least one of the at least one control pattern, including the set of control parameters, the feedback data. The one or more privacy configurations may include a public configuration and a private configuration. In the public configuration, a user, such as the creator 106 may set a scope for the at least one control pattern. The scope may include the set of control parameters, the feedback data generated based on the operation of the at least one control pattern, the artificial intelligence (AI) tags generated by the one or more AI models 224, and the like. The public configuration may allow any of the users 102 to visualize the at least one control pattern in the interactive platform 118. For example, the creator 106 generates a climax master pattern (i.e., the at least one control pattern) in the interactive platform 118. The system 200 stores the set of control parameters, the comments (i.e., the feedback data), the artificial intelligence (AI) tags, and the like of the at least one control pattern. The system 200 renders the at least one control pattern and the associated set of control parameters, the feedback data, and the AI tags to any of the users 102 of the interactive platform 118 based on the receipt of the request.

In the private configuration, the creator 106 may create the at least one control pattern specific to a user, such as the user 102a. The system 200 may encrypt the at least one control pattern including the set of control parameters, feedback data, AI tags, and the like, using an authentication key of the at least one control pattern. The encryption of the at least one control pattern prevents unauthorized accessing of the at least one control pattern by unauthorized users (e.g., the user 102b and the user 102c). In one embodiment, the users 102b-102c may interact with the creator 106 to request the authentication key via a private communication. For example, the creator 106 may create a voice bullet screen pattern (i.e., the at least one control pattern) associated with the timestamps for a viewer A (i.e., the user 102a). The system 200 encrypts the voice bullet screen pattern using a password (i.e., the at least one key parameter) to prevent access to the voice bullet screen pattern for a viewer B (i.e., the user 102b) and a viewer C (i.e., the user 102c). The viewers B and C may need to enter the password to access the voice bullet screen pattern. In another example, the user 102a and the user 102b may establish a private communication. In a similar manner, the user 102a and the user 102b may exchange the at least one control pattern in the encrypted form.

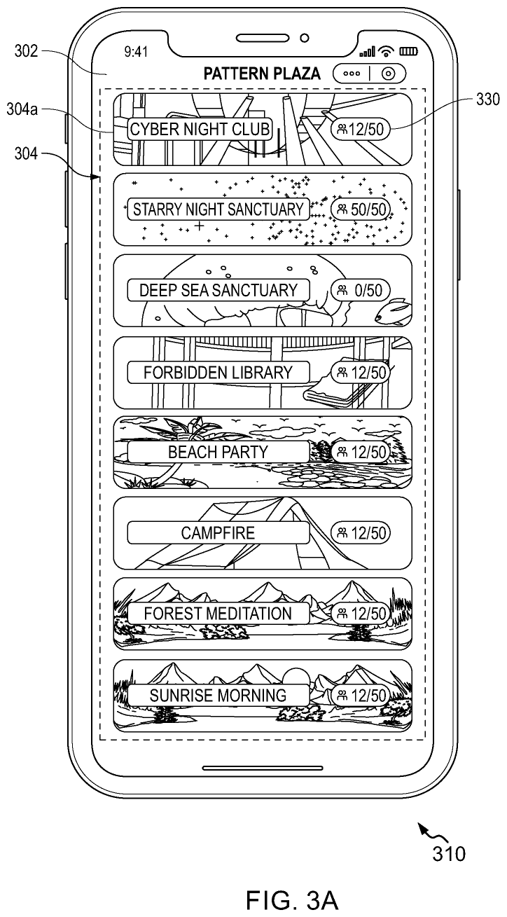

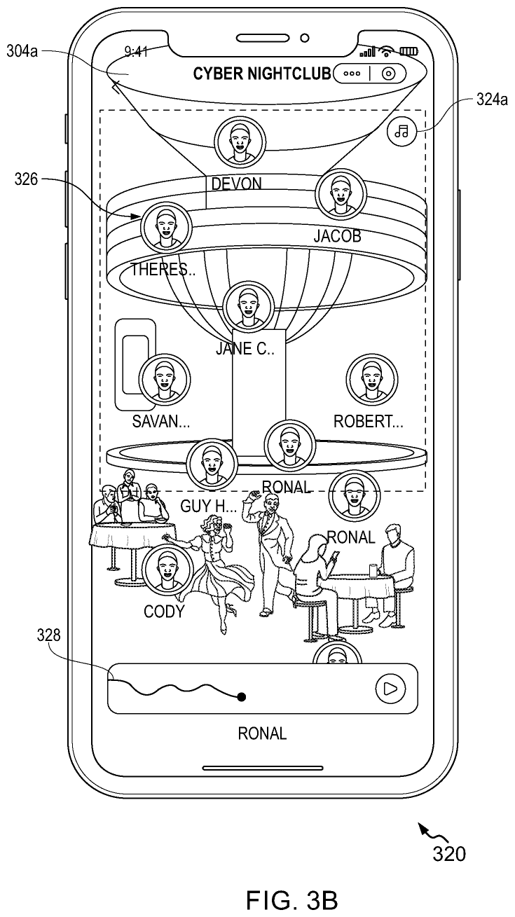

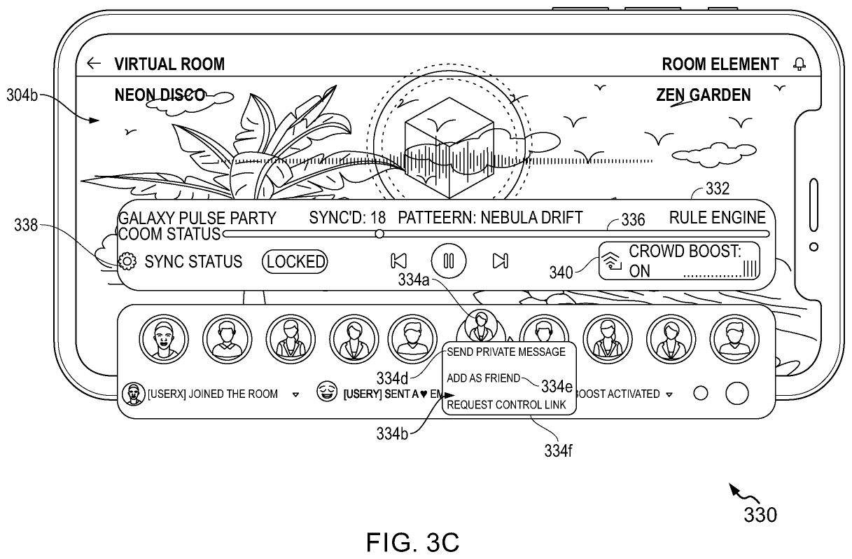

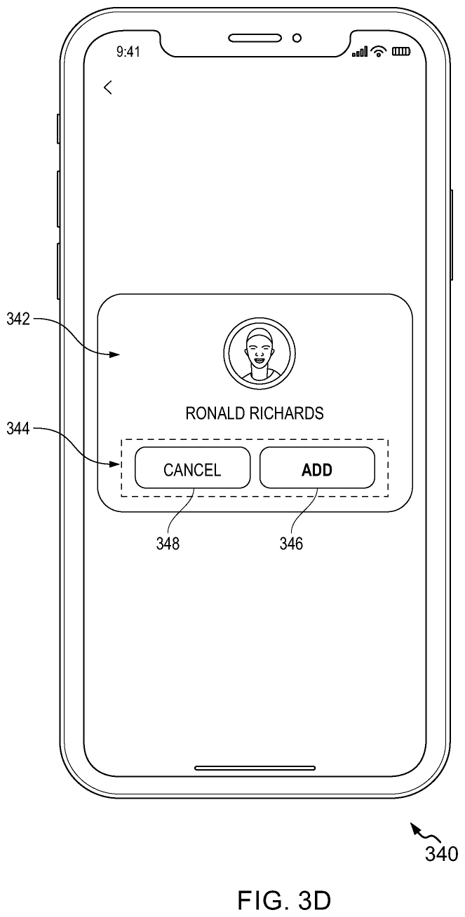

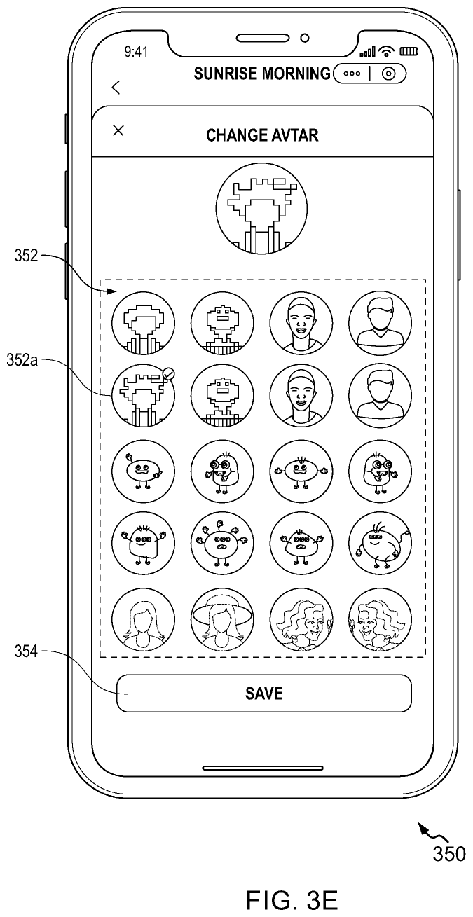

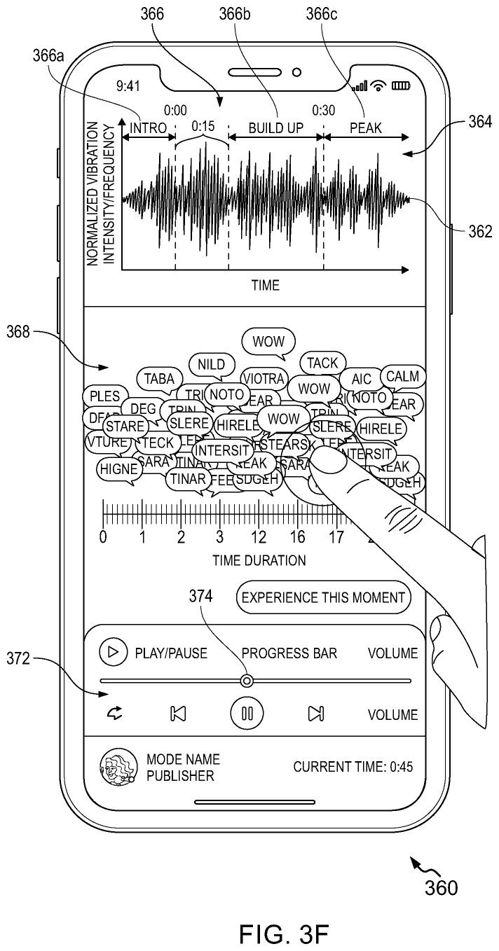

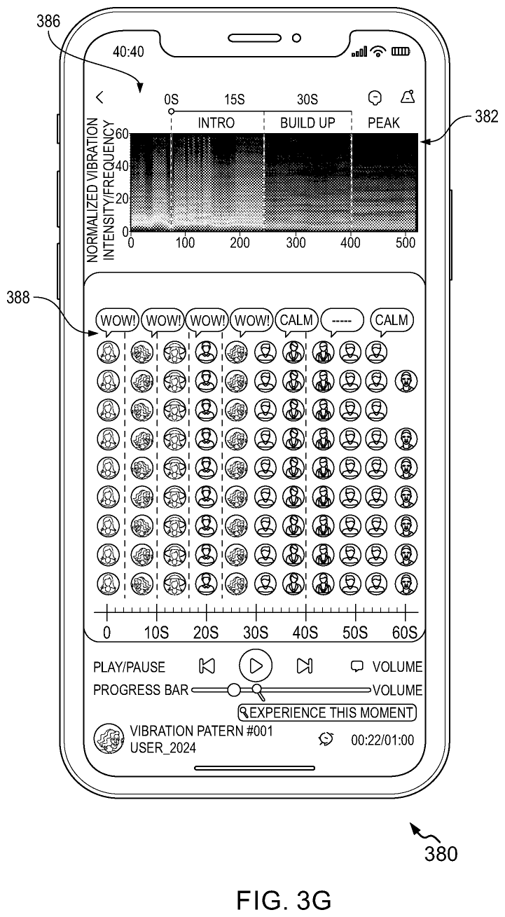

Further, the system 200 transmits a connectivity request initiated by the user 102a to the creator 106 or another user 102b of the interactive platform 118. Upon receiving an approval message for the connectivity request from the creator 106 or user 102b, the system 200 establishes a connectivity between the user 102a and the creator 106/user 102b, enabling mutual control of the corresponding sexual stimulation devices. The system 200 receives an input including the timestamp of the segment of the at least one control pattern segment from the user 102a through the interactive platform 118. The input may include at least one of the set of interactive inputs, the feedback data, and the like. In one embodiment, the input may be provided by at least one of the user 102 and the creator 106. In another embodiment, the system 200 may automatically track the feedback data within the virtual room as described above. In some embodiments, the system 200 may receive the feedback data from multiple users (e.g., the user 102a and the user 102b). The feedback data received from the multiple users is updated as the set of updated interactive contents and augmented in the at least one control pattern. Thereby, enabling a multi-user co-creation of the at least one control pattern to receive the feedback data. The system 200 retrieves the segment of the at least one control pattern and associated control parameter of the segment from the set of control parameters of the at least one control pattern based on the timestamp of the segment of the at least one control pattern. So, receiving the feedback data and updating the at least one control pattern in the one-to-one control scenario, where the at least one control pattern is accessible from the interactive platform 118 without the usage of virtual room scenario, are similar or can be applied to the virtual room scenario. FIG. 3A illustrates an exemplary representation of a user interface (UI) 300 of a virtual room homepage 302 rendered in the interactive platform 118, in accordance with an embodiment of the present disclosure. The user interface 300 may render one or more virtual rooms 304 in the interactive platform 118. Each virtual room of the one or more virtual rooms 306 may be associated with the at least one control pattern to operate the at least one sexual stimulation device 110 and the at least one sexual stimulation device 112a-112c. The user 102a of the users 102 may select the virtual room 304a of the one or more virtual rooms 304 to access the virtual room 304a. The system 200 facilitates access to the virtual room 304a associated with the at least one control pattern to the user 102a. Furthermore, the one or more virtual rooms 304 include a participants list section 330 to indicate the number of participants (i.e., the users 102) and a maximum number of participants allowed in the virtual room 304a. For example, “12” in the participant list section 330 may indicate the number of participants in the virtual room 304a, and “50” in the participant list section 330 may indicate the maximum number of participants in the virtual room 304a. It is to be noted that for illustration purposes, only 50 maximum of participants are depicted, however, there may be any number of participants in the virtual room 304a.

In some optional embodiments, the system provides enhanced features to further improve pattern creation, visualization, and sharing.

In some optional embodiments, animated visualization with AI enhancement: when creating or editing a control pattern, the user terminal displays a plurality of scenario-based animation templates (e.g., roller coaster, surfing, bouncing ball) that simulate short-term rhythmic movements matching the pattern's dynamic characteristics. The system automatically maps the pattern's curve data (intensity and frequency over time) to the selected animation, for example, high-intensity segments correspond to a roller coaster descent or large surfing waves, while low-intensity segments correspond to gentle climbing or small waves. During the creation process, the user may input preferences such as “stronger” via voice, text, or one-click buttons; an AI model parses the input and adjusts the pattern's control parameters (increasing intensity, accelerating rhythm) and synchronously updates the animation to be more dynamic (e.g., faster movement, brighter colors).

In some optional embodiments, the system supports multi-axis sensor-based pattern creation (3D pattern) for sexual stimulation devices. A sexual stimulation device (such as a multi-axis stroker or a handheld intimate massager) is integrated with a six-axis inertial measurement unit (IMU), which includes an accelerometer and a gyroscope, and is configured to capture motion data across multiple degrees of freedom, including forward/backward stroking, vertical deflection, axial rotation, yaw, pitch and roll. The device is further equipped with a pressure-sensitive sensor array embedded in its inner sleeve or physical contact surface, which is configured to collect contact pressure amplitude and spatial pressure distribution data. During pattern creation, a creator manipulates the device through natural physical actions, including pushing, pulling, rotating, squeezing and applying variable pressure; the six-axis IMU samples motion data including movement trajectory, linear velocity, acceleration, angular velocity and device orientation at a frequency of 100 Hz, while the pressure sensor array synchronously collects real-time pressure data. The user terminal, which runs the interactive platform application, converts the sampled motion and pressure data into a standardized control parameter set according to a predefined mapping engine. Specifically, linear movement velocity along the main actuation axis is mapped to vibration frequency through a linear or piecewise function, where a velocity range of 0-10 cm/s corresponds to a frequency range of 20-80 Hz and a velocity above 10 cm/s corresponds to 80-150 Hz; contact pressure amplitude ranging from 0-5 N is mapped to vibration intensity (0-100%) via a quadratic curve that improves sensing sensitivity at low pressure levels; and a rotation angle ranging from 0-360 degrees is mapped to specialized composite vibration modes such as left-right alternating pulses or periodic wave sequences. The user terminal simultaneously generates a 3D trajectory animation that reproduces the creator's manipulation path, where pressure distribution is rendered with color coding (blue for low pressure and red for high pressure), and the animation is provided in the interactive platform for remote visualization and preview. During pattern playback, the terminal renders a customizable virtual hand animation that runs synchronously with the device's actuation, and the device reproduces the original motion profile through closed-loop motor control based on the generated control parameters. In other embodiments, the system supports real-time collaborative authoring of 3D control patterns among two or more users. A first user and a second user, each equipped with a sensor-integrated sexual stimulation device, may join a dedicated virtual room for collaborative pattern creation. The system synchronizes the motion data streams of all users by means of a server-distributed reference clock compliant with the IEEE 1588 Precision Time Protocol. Each user's motion and pressure data is stamped with a local timestamp at a 100 Hz sampling rate and uploaded to the system through an encrypted WebSocket channel. The system merges the multiple data streams into a single composite control parameter set according to a user-selectable fusion rule, including an alternating mode that switches motion segments between users every five seconds, a simultaneous mode that generates two parallel command tracks applicable to a dual-motor device or two independent devices connected to the same terminal, and a dominant mode that dynamically selects data from the user whose motion intensity exceeds a preset threshold. The merged pattern is displayed on each user's terminal as a split-screen 3D animation with distinct color coding for different users' trajectories. Users may submit timestamped voice or text comments during the collaborative session, and the system automatically converts such comments into bullet comments and associates them with corresponding timeline positions to form a complete interactive record. To improve the quality of sensor-generated control patterns, the system incorporates an AI-powered motion refinement engine. The engine takes raw six-axis IMU data and pressure sensor data as input and outputs smoothed and normalized control parameters. The engine is implemented as a 1D convolutional neural network (CNN) with an encoder-decoder architecture, trained on a dataset of expert-annotated human motion samples. The neural network performs temporal denoising to suppress high-frequency signal noise, corrects sensor drift by subtracting a baseline calculated from the first 0.5 seconds of stationary data, interpolates missing data packets caused by transmission loss using a bidirectional long short-term memory (LSTM) network, and applies user-controllable vividness enhancement that increases the variance of the intensity curve by a factor ranging from 1.0 to 2.0. The refined parameters are stored as the final control pattern, and the user terminal provides a comparative view of raw and refined waveforms. The engine also generates textual feature labels including fast thrusting, slow rotation and squeeze pulses through a pre-trained motion classification model, and such labels are incorporated into social feature information to help other users quickly understand pattern characteristics. The sensor-based pattern creation mechanism is further integrated with social functions of the interactive platform. After publishing a 3D pattern along with its 3D trajectory animation, the system provides a ghost replay function for browsing users, which renders a semi-transparent 3D model that animates synchronously with the execution of the control pattern on the user's device. The browsing user may record their own motion while following the ghost replay and compare the two trajectories through an overlay view to evaluate matching accuracy. The system supports privacy configurations including public, friend-only and private for 3D animation data, so that creators may control the sharing scope of their motion recordings.

In some optional embodiments, the system supports adaptive real-time adjustment of sensor-recorded patterns according to individual user characteristics. When a user downloads a 3D pattern created by another user, the system retrieves anonymous metadata of the creator's motion speed and pressure levels, as well as the current user's historical usage statistics. If the current user's average motion speed or pressure is lower than the original creator's, the system automatically scales the speed-to-frequency and pressure-to-intensity mappings using a personalization coefficient. The system performs linear time warping at the user terminal to adjust playback speed or time base, ensuring that the pattern delivers consistent stimulation effects adapted to the user's physical behavior and operation habits.

In some optional embodiments, pattern sharing via unique QR code: the system enables pattern sharing via a unique QR code. After creating a control pattern in the associated application, the creator selects a “Share via QR Code” option to generate a unique QR code cryptographically bound to the pattern's control parameter set (one QR code per pattern). The creator can customize sharing permissions (public/private) and add notes (e.g., “gentle for beginners”). The QR code can be saved as an image and shared via social media, messaging apps, email, or print. When scanned by a user who has the same application installed, the application immediately retrieves the bound pattern from the cloud and prompts “Play Now,” allowing instant playback on the connected sex toy with no additional steps. For a user without the application, scanning the QR code with a mobile camera or third-party scanner redirects to a web page prompting the user to download the application; after installation, re-scanning the QR code grants direct access to the pattern. If the original pattern is edited, the application automatically updates the parameter set associated with the QR code, ensuring subsequent scans retrieve the latest version.

FIG. 3B illustrates an exemplary representation of a user interface (UI) 320 of the virtual room 304a rendered in the interactive platform 118, in accordance with an embodiment of the present disclosure. The system 200 facilitates the rendering of the UI 320 related to the one or more virtual rooms 304, based on the request from the users 102. For example, the system 200 may render the UI 320 of the virtual room 304a to the user 102a based on the request received by the system 200 to access the virtual room 304a. The virtual room 304a rendered in the UI 320 includes a background pattern 322a (i.e., cyber night club) associated with an audio data 324a (i.e., exemplarily depicted as a music icon). Additionally, the background pattern 322a may be associated with one or more animations (e.g., dancing or singing scenarios).

Further, the user interface (UI) 320 renders an avatar 326 for each of the users (e.g., the users 102) in the virtual room 304a. The UI 320 is depicted to include at least one control pattern 328. The at least one control pattern 328 is previewed by the users of the virtual room 304a. Further, the control pattern 328 includes the set of control parameters to operate the at least one sexual stimulation device 110 and the at least one sexual stimulation device 112a-112c while the participants, such as the users 102, are in the virtual room 304a. In one embodiment, the intensity of the actions operated by the control pattern 328 may be related to the background pattern 322a and the audio data 324a associated with the virtual room 304a. Herein, the background pattern 322a and the audio data 324a correspond to the set of virtual room elements of the virtual room 304a. Accordingly, the set of virtual room elements may be dynamically adjusted based on the at least one control pattern 328. In one example scenario, the virtual room 304a may include the control pattern 328 of high intensity. The system 200 adjusts the background pattern 322a (e.g., the cyber night party background) and the audio data 324b (e.g., the upbeat electronic music) of the virtual room 304a based on the intensity of the control pattern 328.

FIG. 3C illustrates an exemplary representation of a user interface (UI) 330 for enabling interaction between the participants of the interactive platform 118, in accordance with an embodiment of the present disclosure. As shown, the UI 330 corresponds to a virtual room. Similar to the UI 320, the UI 330 includes an avatar for each of the participants of the virtual room as shown in UI 330. The system 200 renders at least one control pattern 332 of the virtual room in the virtual room as shown in UI 330. The at least one control pattern 332 allows the participants (i.e., the users 102) to preview the control pattern 332 associated with the virtual room. Additionally, the UI 330 includes a timeline indicator 336 to track the preview of the control pattern 332. The UI 330 includes a sync status indicator 338 (exemplarily depicted as locked) of the control pattern 332 with the at least one sexual stimulation device 110 and the at least one sexual stimulation device 112a-112c. The sync status indicator 338 indicates the synchronous operation state of the at least one sexual stimulation device 110 and the at least one sexual stimulation device 112a-112c with the control pattern 332.

The UI 330 further displays a connectivity request button for the user to send a control connection request to other participants. In one scenario, the participant (i.e., the user 102a) may select an avatar 334a of the user 102b by clicking the avatar 334a of the user 102b in the UI 330. Further, the system 200 renders an interaction interface 334b upon clicking on the avatar 334a. The interaction interface 334b may include one or more options, such as a private message option 334d, an add as friend option 334e, and a request to control option 334f related to the avatar 334a of the user 102a. The private message option 334d may allow the user 102a to request the user 102b to establish an interaction between each other. The user 102a and the users 102b may communicate with each other via the private messages based on a mutual acceptance of the request related to the private message. Further, the request to control option 334f may allow the user 102a to transmit a request to the user 102b to access the control of the at least one sexual stimulation device 112b of the user 102b. The user 102b may accept the request transmitted by the user 102a. The system 200 transmits a control link to the user 102a to operate the at least one sexual stimulation device 112b of the user 102b, and vice-versa. In some embodiments, the request to control option 334f may enable a mutual control between the user 102a and the user 102b. Further, the user 102a may select the add as friend option 334e to establish connection or interaction with other users, such as the user 102b-102c and the creator 106. For example, the user 102a may select the option 334f for establishing the connection with the user 102b in the interactive platform 118. Upon selection of the option 332e, the system 200 transmits a connectivity request to the user 102b. When the user 102a selects the request to control option 334f, the system 200 generates a device control connectivity request carrying the user identifier of the user 102a, the device identifier of the sexual stimulation device 112b of the user 102b, and a control permission application, and transmits the request to the user 102b through the encrypted communication channel of the interactive platform 118. The connectivity request includes a control mode selection (one-way control or mutual control), a control duration limit, and a control parameter scope (intensity, rhythm, segment switching) that the user 102a applies to control the sexual stimulation device 112b, so that the user 102b can clearly confirm the scope and content of the control permission before authorization.

Thereafter, the system 200 renders a user interface (UI) 340 to receive inputs of the user 102b regarding the connectivity request initiated by the user 102a (as shown in FIG. 3D). The UI 340 includes a confirmation window 344 associated with the profile information of the user 102a. The confirmation window 344 may include an add option 346 to accept the connectivity request initiated by the user 102a. The selection of the add option 346 by the user 102b may provide an approval message to the system 200. In response to the receipt of the approval message, the system 200 establishes the connectivity between the user 102a and 102b in the interactive platform 118, thereby allowing interaction between the user 102b and the user 102a in the interactive platform 118. The interaction corresponds to mutual control of the corresponding at least one sexual stimulation device 112a and 112b of the users 102a and 102b. In general, the interaction includes controlling the at least one sexual stimulation device 110 of the creator 106 and the at least one sexual stimulation device 112b-112c of the other users (such as the users 102b-102c) among the plurality of users 102. The selection of the cancel option 348 by the user 102a may directly reject the connectivity request transmitted by the user 102a, and terminates the connectivity. Upon receiving the approval message fed back by the user 102b through the add option 346, the system 200 parses the approval message to obtain the authorization confirmation, the agreed control scope, and the control duration, and the connection management module immediately generates a unique encrypted control authorization token bound to the user identifiers of the user 102a and the user 102b and the device identifiers of the sexual stimulation devices 112a and 112b. The system 200 stores the authorization token and the corresponding permission list in the database 204, and establishes a persistent encrypted control channel between the user device 104a of the user 102a and the user device 104b of the user 102b. For mutual control, the system 200 synchronizes the authorization token to both user devices, and the control instruction generated by either user through the interactive platform 118 is encrypted and forwarded to the controlled user device through the dedicated channel, and the user device converts the control instruction into a control parameter signal matching the sexual stimulation device, so as to realize remote control of the corresponding sexual stimulation device. The system 200 verifies the validity of the authorization token in real time during the control process, and only forwards the control instruction within the scope of the authorized permission, and automatically disconnects the control connection and revokes the authorization token when the control duration expires or either user actively triggers the disconnection instruction, so as to realize safe and stable mutual control of the sexual stimulation devices between users and creators.

FIG. 3E illustrates an exemplary representation of a user interface (UI) 350 to adjust the representation of an avatar related to the user 102c in the interactive platform 118, in accordance with an embodiment of the present disclosure. The UI 350 renders an UI 350 associated with a set of avatar representations 352 to select the avatar for representing in the interactive platform 118. For example, a user, such as the user 102c, may select an avatar 352a from the set of avatar representations 352 and use it for the representation in the interactive platform 118 by providing inputs on a save option 354 in the UI 350.

FIG. 3F illustrates an exemplary representation of a user interface (UI) 360 representing one or more segments 366 of at least one control pattern 362 and corresponding interactive contents in the interactive platform 118, in accordance with an embodiment of the present disclosure. The system 200 represents the one or more segments 366 of the control pattern 362 in a graphical interface 364. The graphical interface 364 illustrates the one or more segments (e.g., “intro”, “buildup”, and “peak”) of the control pattern 362 with a timeline along an X-axis. The intensity of the control pattern 362 is represented along a Y-axis. The one or more segments may include a segment 366a, a segment 366b, and a segment 366c. The control pattern 362 including the segment 366a (e.g., “intro”) corresponds to a defined intensity level of the control pattern 362. Similarly, the control pattern 362 including the segments 366b-366c (e.g., “buildup”, and “peak”) corresponds to respective intensity levels of the control pattern 362. Additionally, the UI 360 renders one or more bullet comments (social feature information) 368 and a timeline scale 370 for the control pattern 362, wherein the bullet comments are synchronized with the timeline timestamps of the control pattern 362. The UI 360 includes a preview interface 372. The preview interface 372 may include a progressive bar 374. The user 102a may traverse along the one or more segments 366 of the control pattern 362 along the timeline using the progressive bar 374 in the preview interface 372 to preview the corresponding interactive contents and control features.

FIG. 3G illustrates an exemplary representation of a user interface (UI) 380 representing one or more segments 386 of at least one control pattern and a heatmap 382 of timestamped feedback data in the interactive platform 118, in accordance with an embodiment of the present disclosure. The system 200 represents the one or more segments 386 of the control pattern in the heatmap 382. The heatmap 382 illustrates the one or more segments (e.g., “intro”, “buildup”, and “peak”) of the control pattern with a timeline along a Y-axis. The intensity of the control pattern is represented along an X-axis of the heatmap 382, and the heatmap 382 further visualizes the density of timestamped feedback data corresponding to the interactive record of the control pattern. The representation of the one or more segments 386 in the heatmap 382 and one or more bullet comments (social feature information) 388 of the control pattern are similar to those of FIG. 3F, and thus are not reiterated for the sake of brevity. The heatmap 382 is generated based on the timestamped feedback data and forms part of the interactive contents for previewing control features of the control pattern.

In one embodiment directed to the interaction between a browsing user and an interactive record, after the system replays the interactive record (e.g., bullet comments or time-synced voice notes) on a second user device associated with the browsing user, the browsing user may perform an interaction operation on a particular experience feedback entry displayed within the interactive record. The experience feedback entry corresponds to a piece of feedback previously provided by the creator or another user, and is associated with a specific timestamp on the timeline of the at least one control pattern. Upon detecting the interaction operation (e.g., a tap, click, or voice command selecting the feedback entry), the system retrieves a control parameter set or a control parameter subset associated with that timestamp. Specifically, if the browsing user selects a feedback entry without specifying a time range, the system retrieves the entire control parameter set of the at least one control pattern. Conversely, if the system is configured to extract a temporal segment, or if the interaction operation implicitly indicates a desire for a segment (e.g., a long-press on a feedback entry that appears at timestamp 1:20), the system retrieves a control parameter subset from the original control parameter set, wherein the subset corresponds to a predetermined window around the timestamp (e.g., from 1:15 to 1:25). The system then transmits the retrieved control parameter set or subset to the second user device. The second user device, in turn, sends the received control parameters to the connected sexual stimulation device, causing the stimulation device to execute the corresponding actions (e.g., vibrations, pulsations, or rotations) that reflect the experience originally associated with the selected feedback entry. This mechanism allows a browsing user to instantly “feel” what the original user commented about at a particular moment without manually navigating the control pattern timeline. Further, after experiencing the control pattern or a segment thereof, the browsing user may input new usage feedback regarding the control parameter set via the second user device. The new usage feedback may be in the form of text, voice, emotion tags, or bullet comments. The system determines a target timestamp corresponding to the input (e.g., the current playback position at the moment of input, or a timestamp explicitly designated by the user). The system then associates the new usage feedback with the control parameter(s) at that target timestamp and merges the new feedback into the existing interactive record, thereby generating an updated interactive record that includes contributions from both the original creator and the browsing user. The updated interactive record is saved in the database and becomes available for subsequent users. In this manner, the interactive record evolves as a multi-user co-created commentary that is time-synchronized with the control pattern, enhancing social engagement and providing a richer preview experience. For example, during replay of the interactive record via the second device of the browsing user, the system 200 supports interactive triggering and feedback enhancement functions corresponding to the interactive record and timestamped experience feedback information. In response to an interaction operation performed by the browsing user on any piece of experience feedback information (i.e., bullet comment or timestamped feedback) in the interactive record through the second device, the system 200 acquires the complete set of control parameters corresponding to the experience feedback information and transmits the complete set of control parameters to the second device, such that the second device sends the control parameters to the browsing user's sexual stimulation device to drive the sexual stimulation device to execute corresponding actions according to the control parameters. Further, upon receiving a trigger instruction from the browsing user with respect to any single piece of experience feedback information in the interactive record, the system 200 parses a timestamp associated with the trigger instruction, acquires a subset of control parameters corresponding to a target time period of the control parameter set according to the timestamp, and transmits the control parameter subset to the second device, so that the second device controls the connected sexual stimulation device based on the subset of control parameters. In addition, during or after replay of the interactive record to the second device, the system 200 receives new usage feedback information input by the browsing user through the second device for the complete set of control parameters, determines a target timestamp corresponding to the new usage feedback information in the timeline of the control pattern, associates the new usage feedback information with the control parameter corresponding to the target timestamp, generates an updated interactive record, and stores the updated interactive record in the database 204 for subsequent browsing, replay and invocation by users.

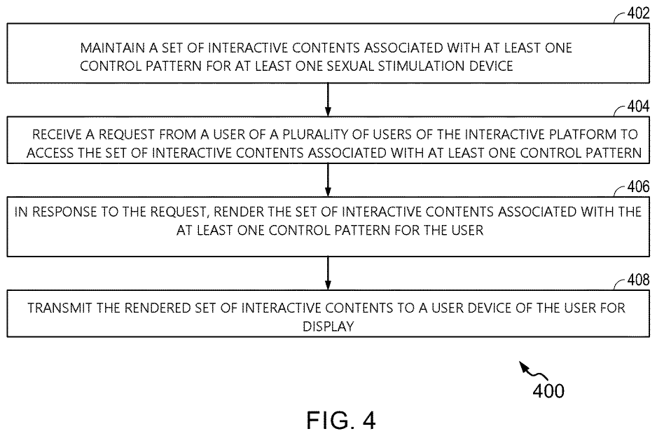

FIG. 4 illustrates a flow diagram of a computer-implemented method 400 for providing the interactive platform 118 to for managing the at least one control pattern related to the adult entertainment activity, in accordance with an embodiment of the present disclosure. The method 400 depicted in the flow diagram may be executed by, for example, the system 200 or the system 120. Operations of the flow diagram of the method 400, and combinations of the operations in the flow diagram of the method 400, may be implemented by, for example, hardware, firmware, a processor, circuitry, and/or a different device associated with the execution of software that includes one or more computer program instructions. It is noted that the operations of the method 400 can be described and/or practiced by using a system other than the system 200. The method 400 starts at operation 402.

At operation 402, the method 400 includes maintaining, by the system 200, a set of interactive contents associated with at least one control pattern for at least one sexual stimulation device, wherein each of the set of interactive contents comprises a set of social feature information generated based on interaction inputs of at least one creator of an interactive platform, and wherein the set of social feature information characterizes control features of the at least one control pattern.

At operation 404, the method 400 includes receiving, by the system 200, a request from a user of a plurality of users of the interactive platform to access the set of interactive contents associated with the at least one control pattern.

At operation 406, the method 400 includes rendering, by the system 200, the set of interactive contents associated with the at least one control pattern for the user, wherein the rendered interactive contents enable a preview of at least a portion of the control features of the control pattern.

At operation 408, the method 400 includes transmitting, by the system 200, the rendered interactive contents to the user device 104a of the user 102a for display, and receiving an interaction instruction from the user 102a to access the at least one control pattern. The at least one control pattern operates at least one sexual stimulation device 112a communicably coupled with the user device 104a of the user 102a to perform the set of actions for providing stimulation to the user 102. Further, one or more operations related to providing adult entertainment using the at least one control pattern are described in detail with reference to FIG. 1 to FIGS. 3A-3G, therefore they are not reiterated for the sake of brevity.

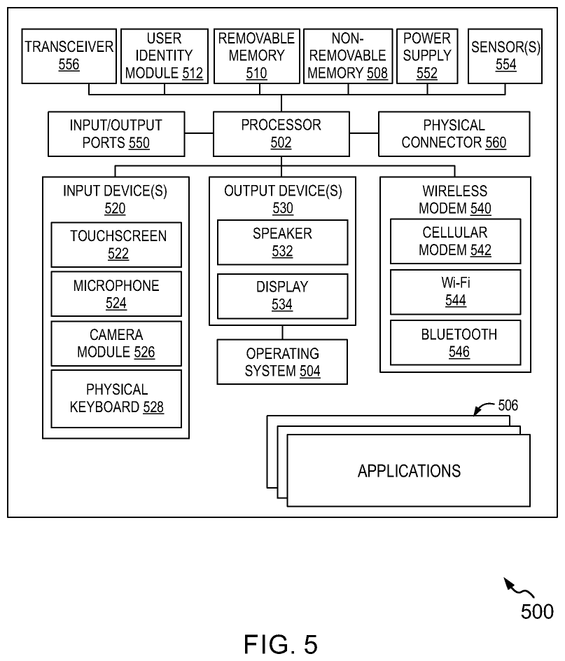

FIG. 5 is a simplified block diagram of an electronic device 500 capable of implementing various embodiments of the present disclosure (supporting the functions of interactive platform, interactive contents preview, control pattern execution, and interactive record replay). For example, the electronic device 500 may correspond to the user terminal 108, and the user devices 104a-104c of FIG. 1. The electronic device 500 is depicted to include one or more applications 506. For example, the one or more applications 506 may include the interactive platform 118 of FIG. 1. The one or more applications 506 installed on the electronic device 500 is capable of communicating with a server (i.e., the system 200 or the system 120) to render the interactive platform 118 for managing adult entertainment, including rendering interactive contents, replaying interactive records, and executing control patterns for sexual stimulation devices.

It should be understood that the electronic device 500, as illustrated and hereinafter described is merely illustrative of one type of device and should not be taken to limit the scope of the embodiments. As such, it should be appreciated that at least some of the components described below in connection with the electronic device 500 may be optional and thus in an embodiment may include more, less, or different components than those described in connection with the embodiment of the FIG. 5. As such, among other examples, the electronic device 500 could be any mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 500 includes a controller or a processor 502 (e.g., a signal processor, microprocessor, ASIC, or other control and processing logic circuitry) for performing such tasks as signal coding, data processing, image processing, input/output processing, power control, and/or other functions. An operating system 504 controls the allocation and usage of the components of the electronic device 500 and supports one or more operations of the application (see, the applications 506) that implements one or more of the innovative features described herein. In addition, the applications 506 may include common mobile computing applications (e.g., telephony applications, email applications, calendars, contact managers, web browsers, messaging applications) or any other computing application.

The illustrated electronic device 500 includes one or more memory components, for example, a non-removable memory 508 and/or removable memory 510. The non-removable memory 508 and/or the removable memory 510 may be collectively known as a database in an embodiment. The non-removable memory 508 can include RAM, ROM, flash memory, a hard disk, or other well-known memory storage technologies. The removable memory 510 can include flash memory, smart cards, or a Subscriber Identity Module (SIM). The one or more memory components can be used for storing data and/or code for running the operating system 504 and the applications 506. The electronic device 500 may further include a user identity module (UIM) 512. The UIM 512 may be a memory device having a processor built in. The UIM 512 may include, for example, a subscriber identity module (SIM), a universal integrated circuit card (UICC), a universal subscriber identity module (USIM), a removable user identity module (R-UIM), or any other smart card. The UIM 512 typically stores information elements related to a mobile subscriber. The UIM 512 in the form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 500 can support one or more input devices 520 and one or more output devices 530. Examples of the input devices 520 may include, but are not limited to, a touch screen/a display screen 522 (e.g., capable of capturing finger tap inputs, finger gesture inputs, multi-finger tap inputs, multi-finger gesture inputs, or keystroke inputs from a virtual keyboard or keypad), a microphone 524 (e.g., capable of capturing voice input), a camera module 526 (e.g., capable of capturing still picture images and/or video images) and a physical keyboard 528. Examples of the output devices 530 may include, but are not limited to, a speaker 532 and a display 534. Other possible output devices can include piezoelectric or other haptic output devices. Some devices can serve more than one input/output function. For example, the touch screen 522 and the display 534 can be combined into a single input/output device.

A wireless modem 540 can be coupled to one or more antennas (not shown in FIG. 5) and can support two-way communications between the processor 502 and external devices, as is well understood in the art. The wireless modem 540 is shown generically and can include, for example, a cellular modem 542 for communicating at long range with the mobile communication network, a Wi-Fi compatible modem 544 for communicating at short range with an external Bluetooth-equipped device, or a local wireless data network or router, and/or a Bluetooth-compatible modem 546. The wireless modem 540 is typically configured for communication with one or more cellular networks, such as a GSM network for data and voice communications within a single cellular network, between cellular networks, or between the electronic device 500 and a public switched telephone network (PSTN). The wireless modem 540 further supports real-time transmission of interactive contents, control patterns, timestamped feedback data, and interactive records between the electronic device 500 and the system 200/120.

The electronic device 500 can further include one or more input/output ports 550, a power supply 572, one or more sensors 574 for example, an accelerometer, a gyroscope, a compass, or an infrared proximity sensor for detecting the orientation or motion of the electronic device 500 and biometric sensors for scanning biometric identity of an authorized user, a transceiver 556 (for wirelessly transmitting analog or digital signals) and/or a physical connector 560, which can be a USB port, IEEE 1294 (FireWire) port, and/or RS-232 port. The illustrated components are not required or all-inclusive, as any of the components shown can be deleted and other components can be added.

The disclosed method with reference to FIG. 4, or one or more operations of the system 200 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or Digital Signal Processor (DSP) circuitry).

Particularly, the system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which are disclosed. Therefore, although the disclosure has been described based on these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
maintaining, by a system, a set of interactive contents associated with at least one control pattern for at least one sexual stimulation device, wherein each of the set of interactive contents comprises a set of social feature information generated based on interaction inputs of at least one creator of an interactive platform, and wherein the set of social feature information characterizes control features of the at least one control pattern;
receiving, by the system, a request from a user of a plurality of users of the interactive platform to access the set of interactive contents associated with the at least one control pattern;
in response to the request, rendering, by the system, the set of interactive contents associated with the at least one control pattern for the user, the rendered set of interactive contents enable a preview of at least a portion of the control features of the at least one control pattern; and
transmitting, by the system, the rendered set of interactive contents to a user device of the user for display.

2. The computer-implemented method as claimed in claim 1, further comprising:
receiving, by the system, an interaction instruction from the user to access the at least one control pattern; and
in response to receipt of the interaction instruction, transmitting, by the system, the at least one control pattern comprising a set of control parameters to the user device of the user, wherein the at least one control pattern operates at least one sexual stimulation device communicably coupled with the user device of the user to perform a set of actions for providing stimulation to the user.

3. The computer-implemented method as claimed in claim 2, further comprising:
receiving, by the system, feedback data from the user corresponding to the operation of the at least one sexual stimulation device using the at least one control pattern comprising the set of control parameters;
generating, by the system, a set of updated interactive contents corresponding to the feedback data of the user; and
augmenting, by the system, the set of updated interactive contents to the set of interactive contents corresponding to the at least one pattern based on one or more rules and a corresponding timestamp of the at least one control pattern.

4. The computer-implemented method as claimed in claim 1, wherein the at least one control pattern comprises the set of control parameters corresponds to a temporal discrete command sequence, and wherein each control parameter of the at least one control pattern corresponding to the temporal discrete command sequence is arranged in a sequential manner based at least on a timestamp associated with each control parameter of the set of control parameters;
wherein the set of social feature information are configured to be associated with the set of control parameters and are sequentially arranged according to a same chronological order of the timeline.

5. The computer-implemented method as claimed in claim 1, wherein each of the set of interactive contents is configured to be a virtual room associated with at least one control pattern, wherein the set of social feature information comprises a set of virtual room elements;
wherein the method further comprising:
creating, by the system, one or more virtual rooms in the interactive platform, wherein each virtual room of the one or more virtual rooms is appended with the at least one control pattern comprising the set of control parameters; and
generating, by the system, the set of virtual room elements for each of the one or more virtual rooms based on the analysis of the set of control parameters of the at least one control pattern associated with each of the one or more virtual rooms, wherein the set of virtual room elements comprises at least one of a background pattern, animations, and audio data.

6. The computer-implemented method as claimed in claim 5, further comprising:
receiving, by the system, a request from the plurality of users to access a virtual room of the one or more virtual rooms on the interactive platform;
in response to receipt of the request, facilitating, by the system, the plurality of users to access the virtual room of the one or more virtual rooms through the interactive platform; and
transmitting, by the system, the at least one control pattern comprising the set of control parameters associated with the virtual room to each of the plurality of users of the virtual room, wherein the at least one control pattern comprising the set of control parameters associated with the virtual room allows synchronous control of at least one sexual stimulation device of each of the plurality of users in the virtual room.

7. The computer-implemented method as claimed in claim 6, further comprising:
monitoring, by the system, one or more conditions associated with the virtual room in real-time, the one or more conditions comprising feedback data, a number of users in the virtual room, and predefined settings defined by the creator of the virtual room;
dynamically generating, by the system, a modified set of control parameters for the at least one control pattern associated with the virtual room corresponding to the one or more conditions; and
transmitting, by the system, the at least one control pattern comprising the set of modified control parameters to each of the plurality of users of the virtual room, thereby enabling synchronous control of the corresponding at least one sexual stimulation device of each of the plurality of users in the virtual room based on the at least one control pattern comprising the set of modified control parameters.

8. The computer-implemented method as claimed in claim 1, further comprising:
generating, by the system, one or more segments in the at least one control pattern based on implementing one or more artificial intelligence (AI) models, wherein the one or more AI models are configured to generate the one or more segments in the at least one control pattern based on analyzing a waveform of the at least one control pattern and the set of control parameters and associated timestamp of each control parameter of the set of control parameters of the at least one control pattern.

9. The computer-implemented method as claimed in claim 8, further comprising:
receiving, by the system, an input comprising the timestamp of the segment of the at least one control pattern from the user through the interactive platform;
retrieving, by the system, the segment of the at least one control pattern and associated control parameter of the segment from the set of control parameters of the at least one control pattern based on the timestamp of the segment of the at least one control pattern; and
transmitting, by the system, the segment of the at least one control pattern and associated control parameter of the segment to the user, thereby enabling the user to control at least one sexual stimulation device corresponding to the segment of the at least one control pattern.

10. The computer-implemented method as claimed in claim 1, further comprising:
transmitting, by the system, a connectivity request initiated by the user of the plurality of users to one of the creator and other users among the plurality of users of the interactive platform;
receiving, by the system, an approval message for the connectivity request initiated by the user from one of the creator and the other users among the plurality of users of the interactive platform; and
in response to the receipt of the approval message, facilitating, by the system, establishment of the connectivity between the user and one of the creator and the other users among the plurality of users in the interactive platform for allowing interaction between the user and one of the creator and the other users among the plurality of users in the interactive platform, wherein the interaction corresponds to controlling at least one sexual stimulation device of the creator and at least one sexual stimulation device of the other users among the plurality of users.

11. A system, comprising:
a memory storing executable instructions; and
a processor operatively coupled with the memory, the processor configured to execute the executable instructions to cause the system to at least:
maintain a set of interactive contents associated with at least one control pattern for at least one sexual stimulation device, wherein each of the set of interactive contents comprises a set of social feature information generated based on interaction inputs of at least one creator of an interactive platform, and wherein the set of social feature information characterizes control features of the at least one control pattern;
receive a request from a user of a plurality of users of the interactive platform to access the set of interactive contents associated with the at least one control pattern;
in response to the request, render the set of interactive contents associated with the at least one control pattern for the user, the rendered set of interactive contents enable a preview of at least a portion of the control features of the at least one control pattern; and
transmit the rendered set of interactive contents to a user device of the user for display.

12. The system as claimed in claim 11, wherein the system is further caused to:
receive an interaction instruction from the user to access the at least one control pattern; and
in response to receipt of the interaction instruction, transmit the at least one control pattern comprising a set of control parameters to a user device of the user, wherein the at least one control pattern operates at least one sexual stimulation device communicably coupled with the user device of the user to perform a set of actions for providing stimulation to the user.

13. The system as claimed in claim 11, wherein the system is further caused to:
receive feedback data from the user corresponding to the operation of at least one sexual stimulation device using the at least one control pattern comprising the set of control parameters;
generate a set of updated interactive contents corresponding to the feedback data of the user; and
augment the set of updated interactive contents to the set of interactive contents corresponding to the at least one pattern based on one or more rules and a corresponding timestamp of the at least one control pattern.

14. The system as claimed in claim 11, wherein the at least one control pattern comprising the set of control parameters corresponds to a temporal discrete command sequence, and wherein each control parameter of the at least one control pattern corresponding to the temporal discrete command sequence is arranged in a sequential manner based at least on a timestamp associated with each control parameter of the set of control parameters;
wherein the set of social feature information are configured to be associated with the set of control parameters and are sequentially arranged according to a same chronological order of the timeline.

15. The system as claimed in claim 11, wherein each of the set of interactive contents is configured to be a virtual room associated with at least one control pattern, wherein the set of social feature information comprises a set of virtual room elements;
wherein the system is further caused to:
create one or more virtual rooms in the interactive platform, wherein each virtual room of the one or more virtual rooms is appended with the at least one control pattern comprising the set of control parameters; and
generate the set of virtual room elements for each of the one or more virtual rooms based on the analysis of the set of control parameters of the at least one control pattern associated with each of the one or more virtual rooms, wherein the set of virtual room elements comprises at least one of a background pattern, animations, and audio data.

16. The system as claimed in claim 15, wherein the system is further caused to:
receive a request from the plurality of users to access a virtual room of the one or more virtual rooms on the interactive platform;
in response to receipt of the request, facilitate the plurality of users to access the virtual room of the one or more virtual rooms through the interactive platform; and
transmit the at least one control pattern comprising the set of control parameters associated with the virtual room to each of the plurality of users of the virtual room, wherein the at least one control pattern comprising the set of control parameters associated with the virtual room allows synchronous control of at least one sexual stimulation device of each of the plurality of users in the virtual room.

17. The system as claimed in claim 16, wherein the system is further caused to:
monitor one or more conditions associated with the virtual room in real-time, the one or more conditions comprising feedback data, a number of users in the virtual room, and predefined settings defined by the creator of the virtual room;
dynamically generate a modified set of control parameters for the at least one control pattern associated with the virtual room corresponding to the one or more conditions; and
transmit the at least one control pattern comprising the set of modified control parameters to each of the plurality of users of the virtual room, thereby enabling synchronous control of the corresponding at least one sexual stimulation device of each of the plurality of users in the virtual room based on the at least one control pattern comprising the set of modified control parameters.

18. The system as claimed in claim 11, wherein the system is further caused to:
generate one or more segments in the at least one control pattern based on implementing one or more artificial intelligence (AI) models, wherein the one or more AI models are configured to generate the one or more segments in the at least one control pattern based on analyzing a waveform of the at least one control pattern and the set of control parameters and associated timestamp of each control parameter of the set of control parameters of the at least one control pattern.

19. The system as claimed in claim 18, wherein the system is further caused to:
receive an input comprising the timestamp of the segment of the at least one control pattern from the user through the interactive platform;
retrieve the segment of the at least one control pattern and associated control parameter of the segment from the set of control parameters of the at least one control pattern based on the timestamp of the segment of the at least one control pattern; and
transmit the segment of the at least one control pattern and associated control parameter of the segment to the user, thereby enabling the user to control at least one sexual stimulation device corresponding to the segment of the at least one control pattern.

20. A computer-implemented method, comprising:
receiving, by a system, a plurality of feedback data regarding at least one control pattern from a creator of an interactive platform via a first device during a period in which the creator applies the at least one control pattern to control at least one sexual stimulation device or creates the at least one control pattern, and determining timestamps on a timeline of the at least one control pattern corresponding to input of each of the plurality of feedback data;
associating, by the system, each of the plurality of feedback data with a corresponding timestamp on the timeline of the at least one control pattern to generate an interactive record corresponding to the at least one control pattern; wherein the interactive record is configured to, upon being replayed, present the plurality of feedback data sequentially based on a chronological order of the timestamps on the timeline of the at least one control pattern;
saving, by the system, the interactive record; and
in response to receiving a browse request for the interactive record from a user of the interactive platform via a second device, replaying, by the system, the interactive record via the second device to present the plurality of feedback data sequentially based on the chronological order of the timestamps on the timeline of the at least one control pattern.
